(19) United States
(12) Patent Application Publication
(10) Pub. No.: US 2026/0177406 A1
(43) Pub. Date: Jun. 25, 2026

(54) Systems And Methods For Foreign Object Detection In Wireless Power Transfer

(71) Applicant: WiTricity Corporation, Midway, GA (US)

(72) Inventors: José Pedro CASTRO FONSECA, Oetwil an der Limmat (CH); Andreas DAETWYLER, Muhen (CH); Mircea-Florian VANCU, Dietikon (CH)

(21) Appl. No.: 19/084,232

(22) Filed: Mar. 19, 2025

Related U.S. Application Data
(60) Provisional application No. 63/567,287, filed on Mar. 19, 2024.

(51) Int. Cl. G01D 5/20; B60L 53/124; G01D 5/24; H02J 50/12; H02J 50/60

(52) U.S. Cl. CPC G01D 5/204; B60L 53/124; G01D 5/2403; H02J 50/12; H02J 50/60

(57) ABSTRACT

The present disclosure provides systems and methods for foreign object detection within wireless power transfer systems. The disclosure comprises: generating a first probability distribution function (PDF) from a first dataset of FOD sensitivity values, the first dataset representing a foreign object detection threshold; generating a second PDF from a second dataset of foreign object detection values for an object; determining, by the processor, using the first PDF and the second PDF, a third PDF representing a probability of a missed detection of the object. The present disclosure aims to improve missed foreign object detection by providing more accurate foreign object detection and modification of parameters associated therewith, in wireless power transfer systems, to mitigate the associated efficiency and safety effects of missed detections.

### REFERENCE TO RELATED APPLICATIONS

This application claims priority and benefit from U.S. Provisional Patent Application 63/567,287, filed Mar. 19, 2024, the disclosure of which is hereby incorporated by reference herein in its entirety.

### TECHNICAL FIELD

The present disclosure is directed to wireless power transfer systems, and particularly directed to foreign object detection within wireless power transfer systems.

### BACKGROUND

Inductive wireless power transfer (WPT) has emerged as a promising technology for electric vehicle (EV) charging, offering the convenience of cordless charging for EVs. This technology relies on electromagnetic fields to transfer power from a charging pad or coil, which may for example be embedded in the ground, to a receiver coil on an EV, eliminating the need for physical connectors. The widespread adoption of WPT systems for EV charging may be helped by improved foreign object detection (FOD).

FOD refers to the presence of foreign objects, such as metallic debris or other conductive materials on or proximate the charging pad or coil, or within the vicinity of the WPT system. These foreign objects, in some cases, can disrupt the magnetic field generated during by the WPT system charging, leading to reductions in power transfer efficiency and electromagnetic interference.

One of the primary considerations in WPT for EV charging is ensuring robust FOD detection capabilities. Existing detection methods, such as magnetic field sensing and impedance monitoring, may have limitations in terms of accuracy and sensitivity. Moreover, the dynamic nature of EV charging environments, including varying weather conditions and different types of surfaces, further complicates FOD detection. In particular, the presence of an EV proximate the charging pad or coil during charging can in some cases have the effect of confounding FOD systems, increasing the likelihood of a missed detection.

Addressing these issues may help the widespread adoption of WPT systems for EV charging. Robust FOD detection mechanisms may improve reliability of the charging infrastructure and ensure efficient power transfer.

In summary, while WPT holds great promise for revolutionising EV charging, effective FOD detection remains an important area of focus to overcome existing challenges and realise the full potential of this technology.

### SUMMARY OF THE DISCLOSURE

In accordance with a first aspect of the present disclosure, there is provided a computer-implemented method for foreign object detection (FOD) in a wireless power transfer (WPT) system (for example an inductive WPT), the method comprising: generating, using control circuitry, a first probability distribution function (PDF) from a first dataset of FOD sensitivity values, the first dataset representing a foreign object detection threshold; generating, using control circuitry, a second PDF from a second dataset of foreign object detection values for an object; and determining, using control circuitry, based on first PDF and the second PDF, a third PDF representing a probability of a missed detection of the object.

In some embodiments, the method may further comprise accessing the first dataset and the second dataset. It will be appreciated that in some embodiments the first dataset and the second dataset may be dynamic and may be independently or collectively amended or updated, for example by adding further sensitivity values or foreign object detection values (for example inductive or capacitive response values) thereto, or subtracting corresponding values therefrom. It will be appreciated that any accessing of the first dataset or the second dataset may therefore comprise accessing the updated first dataset or the updated second dataset.

In some embodiments, the method may further comprise detecting, using control circuitry, that a foreign object is within a proximity of a WPT surface of a WPT system. The detecting may be performed in any suitable manner such as described herein, using a FOD system.

In some embodiments, the method may further comprise modifying, using control circuitry, based on the third PDF, the foreign object detection threshold for detecting the object by the WPT system.

In some embodiments, the method may further comprise outputting a warning of a foreign object detection event based on the modified foreign object detection threshold. Any suitable warning may be appreciated and may, for example comprise a visible warning, an audible warning, or any combination thereof.

In some embodiments, the method further comprises: defining a missed detection probability of the WPT system based on the third PDF.

In some embodiments, defining the missed detection probability comprises summing the third PDF across one or more regions of interest.

In some embodiments, the method further comprises: modifying, using control circuitry, based on the third PDF, the foreign object detection threshold for detecting an object (such as the object) by the WPT system. In some embodiments, the method may comprise detecting, using control circuitry, a foreign object using the modified foreign object detection threshold.

In some embodiments, the foreign object detection threshold is selected from a foreign object detection threshold range between a minimum detection threshold and a maximum detection threshold.

In some embodiments, modifying the foreign object detection threshold based on the third PDF comprises modifying the detection threshold range.

In some embodiments, the FOD sensitivity values comprise, or are associated with, one or more selected from: one or more object detection sensors (for example sensor loops N) indicating responses (such as inductive responses or capacitive responses) above the detection threshold (for example a minimum detection threshold tₘᵢₙ); a magnitude of the responses t.

In some embodiments, the first dataset comprises time series data.

In some embodiments, the first dataset is obtained or accessed by measuring the FOD sensitivity values using a plurality of object detection sensors of a FOD system of the WPT system, during a period of normal use of the WPT system, and in the absence of the object.

In some embodiments, selecting the detection threshold along the detection threshold range comprises: determining from the plurality of object detection sensors, a number of the sensors indicating the proximity of an object; and selecting the detection threshold from along the range of the detection thresholds according to the number of sensors.

In some embodiments, the proximity of the selected detection threshold to the maximum detection threshold of the range is correlated (for example directly correlated) with the number of sensors indicating the proximity of an object.

In some embodiments, the foreign object detection values comprise, or are associated with, one or more selected from: a response (such as an inductive or capacitive response) caused by an object; a location of a response (such as an inductive or capacitive response) caused by an object.

In some embodiments, the second dataset is obtained or accessed by measuring the foreign object detection values using a FOD system of the WPT system, during a period of normal use of the WPT system, and in the presence of the object.

In some embodiments, the FOD system of the WPT system comprises one or more object detection sensors disposed proximate a WPT surface (such as an inductive surface) of the WPT system, the one or more object detection sensors arranged to detect a change in a foreign object detection parameter for generating the foreign object detection values, and wherein the second dataset is obtained or accessed by positioning the object proximate the WPT surface at one or more locations relative to the one or more object detection sensors (such as object detection sensor loops).

In some embodiments, the second dataset is obtained or accessed by positioning the object at each location of a plurality of the locations.

In some embodiments, generating the second PDF comprises generating a plurality of second PDFs, each second PDF generated from a corresponding second dataset of FOD object detection values for a corresponding object.

In some embodiments, the first, second and third PDFs are first, second and third probability density functions respectively.

In accordance with a further aspect of the present disclosure, there is provided a non-transitory computer readable storage medium storing instructions which, when executed by a processor, cause the processor to perform steps of a method in accordance with the first aspect. Any features described herein as suitable for use in the method of the first aspect will therefore be understood as suitable for use with the non-transitory computer readable storage medium of the disclosure.

In accordance with a further aspect of the present disclosure, there is provided a foreign object detection (FOD) system of an wireless power transfer (WPT) system (such as an inductive WPT system), the FOD system comprising control circuitry configured to: generate a first probability distribution function (PDF) from a first dataset of FOD sensitivity values, the first dataset representing a foreign object detection threshold; generate a second PDF from a second dataset of foreign object detection values for an object; and determine using the first PDF and the second PDF, a third PDF representing a probability of a missed detection of the object.

In some embodiments, the control circuitry may be further configured to access the first dataset and the second dataset. It will be appreciated that in some embodiments the first dataset and the second dataset may be dynamic and may be independently or collectively amended or updated, for example by adding further sensitivity values or foreign object detection values (for example inductive or capacitive response values) thereto, or subtracting corresponding values therefrom. It will be appreciated that any accessing of the first dataset or the second dataset by the control circuitry may therefore comprise accessing the updated first dataset or the updated second dataset.

In some embodiments, the control circuitry may be further configured to detect that a foreign object is within a proximity of a WPT surface of a WPT system. The detecting may be performed in any suitable manner such as described herein, using a FOD system.

In some embodiments, the control circuitry may be further configured to modify, based on the third PDF, the foreign object detection threshold for detecting the object by the WPT system.

In some embodiments, the control circuitry may be further configured to output a warning of a foreign object detection event based on the modified foreign object detection threshold.

In some embodiments, the FOD system is further arranged to: define a missed detection probability based on the third PDF.

In some embodiments, defining the missed detection probability comprises summing the third PDF across one or more regions of interest.

In some embodiments, the FOD system is further arranged to: modify, based on the third PDF, the foreign object detection threshold for detecting an object (such as the object) by the WPT system. In some embodiments, the FOD system may be further configured to detect a foreign object using the modified foreign object detection threshold.

In some embodiments, the foreign object detection threshold is selected from a foreign object detection threshold range between a minimum detection threshold and a maximum detection threshold.

In some embodiments, modifying the foreign object detection threshold comprises modifying the foreign object detection threshold range.

In some embodiments, the FOD sensitivity values comprise, or are associated with, one or more selected from: a number of object detection sensors (for example sensor loops N) indicating responses (such as inductive or capacitive responses) above the detection threshold (for example a minimum detection threshold tₘᵢₙ); a magnitude of the responses t.

In some embodiments, the first dataset comprises time series data.

In some embodiments, the first dataset is obtained or accessed by measuring the FOD sensitivity values using a plurality of object detection sensors of a FOD system of the WPT system, during a period of normal use of the WPT system, and in the absence of the object.

In some embodiments, selecting the detection threshold along the foreign object detection threshold range comprises: determining from the plurality of object detection sensors, a number of the sensors indicating the proximity of an object; and selecting the detection threshold from along the range of the detection thresholds according to the number of sensors.

In some embodiments, the proximity of the selected detection threshold to the maximum detection threshold of the range is correlated (for example directly correlated) with the number of sensors indicating the proximity of an object.

In some embodiments, the foreign object detection values comprise, or are associated with, one or more selected from: a response (such as an inductive or capacitive response) caused by an object; a location of a response (such as an inductive or capacitive response) caused by an object.

In some embodiments, the second dataset is obtained or accessed by measuring the foreign object detection values using a FOD system of the WPT system, during a period of normal use of the WPT system, and in the presence of the object.

In some embodiments, the FOD system of the WPT system comprises one or more object detection sensors disposed proximate a WPT surface (such as an inductive surface) of the WPT system, the one or more object detection sensors arranged to detect a change in a foreign object detection parameter for generating the foreign object detection values, and wherein the second dataset is obtained or accessed by positioning the object proximate the WPT surface at one or more locations relative to the one or more object detection sensors (such as object detection sensor loops).

In some embodiments, the second dataset is obtained or accessed by positioning the object at each location of a plurality of the locations.

In some embodiments, generating the second PDF comprises generating a plurality of second PDFs, each second PDF generated from a corresponding second dataset of FOD object detection values for a corresponding object.

In some embodiments, the first, second and third PDFs are first, second and third probability density functions respectively.

It will be appreciated that any features described herein as being suitable for incorporation into one or more aspects or embodiments of the present disclosure are intended to be generalizable across all aspects and embodiments of the present disclosure.

### BRIEF DESCRIPTION OF THE DRAWINGS

Embodiments of the present disclosure will now be described by way of example only and with reference to the accompanying drawings, in which:

FIG. 1 is a diagram of a wireless power transfer system for charging an electric vehicle, suitable for use in accordance with some implementations;

FIG. 2 is a schematic diagram of core components of the wireless power transfer system of FIG. 1;

FIG. 3 is another functional block diagram showing core and ancillary components of the wireless power transfer system of FIG. 1;

FIG. 4 is a diagram of a simplified circuit for detecting a ferromagnetic foreign object using an inductive sensing coil where the object's electrical conductivity and magnetic permeability are a function of exposure to a biasing static magnetic field, suitable for use in accordance with some implementations;

FIG. 5 is an equivalent circuit diagram of the simplified circuit for detecting the ferromagnetic foreign object of FIG. 4;

FIG. 6 is a time diagram illustrating an effect of intermittent exposure of a ferromagnetic foreign object to a static magnetic field on characteristics of an inductive sensing coil, suitable for use in accordance with some implementations;

FIG. 7 is a diagram of a simplified circuit for detecting a ferromagnetic foreign object using an inductive sensing coil where the object's electrical conductivity and magnetic permeability are a function of exposure to a biasing alternating magnetic field, suitable for use in accordance with some implementations;

FIG. 8 is an equivalent circuit diagram of the simplified circuit for detecting the ferromagnetic foreign object of FIG. 7;

FIG. 9 shows a flow-chart of an example method of improving a calculation of a missed foreign object detection (FOD) probability in an inductive wireless power transfer (WPT) system in accordance with the first aspect;

FIG. 10 shows a histogram depicting an example first PDF generated using a dataset of sensitivity values representing a detection threshold for two example use-case scenarios, as part of a method in accordance with the first aspect;

FIG. 11 shows a histogram depicting an example second PDF generated using a dataset of object detection values for specific known foreign objects, as part of a method in accordance with the first aspect; and

FIG. 12 shows foreign object specific box-plots depicting an example second PDF generated using a dataset of object detection values for specific known foreign objects, relative to a detection threshold, as part of a method in accordance with the first aspect.

### DETAILED DESCRIPTION

The detailed description set forth below in connection with the appended drawings is intended as a description of implementations and is not intended to represent the only implementations in which the invention may be practiced. The term “exemplary” used throughout this description means “serving as an example, instance, or illustration,” and should not necessarily be construed as preferred or advantageous over other implementations. The detailed description includes specific details for the purpose of providing a thorough understanding of the implementations. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into an electro-magnetic field (e.g., a magnetic field) may be received, captured by, or coupled by a “receiving coupler” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

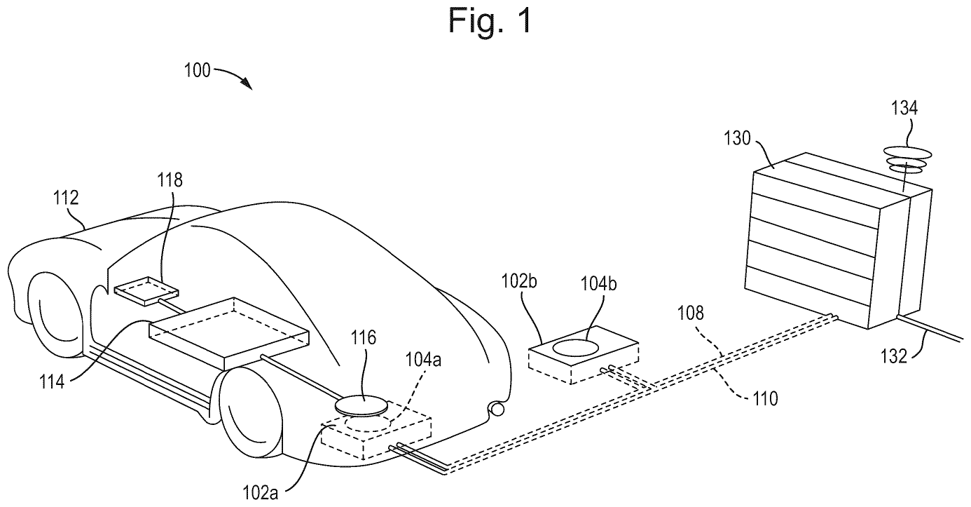

FIG. 1 is a diagram of a wireless power transfer system 100 for charging an electric vehicle 112, in accordance with some implementations. The wireless power transfer system 100 enables charging of an electric vehicle 112 while the electric vehicle 112 is parked near a base wireless charging system 102 a. Spaces for two electric vehicles are illustrated in a parking area to be parked over corresponding base wireless charging system 102 a and 102 b. In some implementations, a local distribution center 130 may be connected to a power backbone 132 and configured to provide an alternating current (AC) or a direct current (DC) supply through a power link 110 to the base wireless charging system 102 a. The base wireless charging system 102 a also includes a base system coupler 104 a for wirelessly transferring or receiving power. An electric vehicle 112 may include a battery unit 118, an electric vehicle coupler 116, and an electric vehicle wireless charging system 114. Each of the base wireless charging systems 102 a and 102 b also includes a base coupler 104 a and 104 b, respectively, for wirelessly transferring power. In some other implementations (not shown in FIG. 1), base couplers 104 a or 104 b may be stand-alone physical units and are not part of the base wireless charging system 102 a or 102 b. The electric vehicle coupler 116 may interact with the base system coupler 104 a for example, via a region of the electromagnetic field generated by the base system coupler 104 a.

In some implementations, the electric vehicle coupler 116 may receive power when the electric vehicle coupler 116 is located in an energy field produced by the base system coupler 104 a. The field corresponds to a region where energy output by the base system coupler 104 a may be captured by an electric vehicle coupler 116. For example, the energy output by the base system coupler 104 a may be at a level sufficient to charge or power the electric vehicle 112. In some cases, the field may correspond to the “near field” of the base system coupler 104 a. The near-field may correspond to a region in which there are strong reactive fields resulting from the currents and charges in the base system coupler 104 a that do not radiate power away from the base system coupler 104 a. In some cases the near-field may correspond to a region that is within about 1/27 of wavelength of the base system coupler 104 a (and vice versa for the electric vehicle coupler 116) as will be further described below.

Local distribution 130 may be configured to communicate with external sources (e.g., a power grid) via a communication backhaul 134, and with the base wireless charging system 102 a via a communication link 108.

In some implementations the electric vehicle coupler 116 may be aligned with the base system coupler 104 a and, therefore, disposed within a near-field region simply by the driver positioning the electric vehicle 112 correctly relative to the base system coupler 104 a. In other implementations, the driver may be given visual, auditory, or tactile feedback, or combinations thereof to determine when the electric vehicle 112 is properly placed for wireless power transfer. In yet other implementations, the electric vehicle 112 may be positioned by an autopilot system, which may move the electric vehicle 112 back and forth (e.g., in zig-zag movements) until an alignment error has reached a tolerable value. This may be performed automatically and autonomously by the electric vehicle 112 without or with only minimal driver intervention provided that the electric vehicle 112 is equipped with a servo steering wheel, ultrasonic sensors, and intelligence to adjust the vehicle. In still other implementations, the electric vehicle coupler 116, the base system coupler 104 a, or a combination thereof may have functionality for displacing and moving the couplers 116 and 104 a relative to each other to more accurately orient them and develop more efficient coupling therebetween.

The base wireless charging system 102 a may be located in a variety of locations. As non-limiting examples, some suitable locations include a parking area at a home of the electric vehicle 112 owner, parking areas reserved for electric vehicle wireless charging modelled after conventional petroleum-based filling stations, and parking lots at other locations such as shopping centers and places of employment.

Charging electric vehicles wirelessly may provide numerous benefits. For example, charging may be performed automatically, virtually without driver intervention and manipulations thereby improving convenience to a user. There may also be no exposed electrical contacts and no mechanical wear out, thereby improving reliability of the wireless power transfer system 100. Manipulations with cables and connectors may not be needed, and there may be no cables, plugs, or sockets that may be exposed to moisture and water in an outdoor environment, thereby improving safety. There may also be no sockets, cables, and plugs visible or accessible, thereby reducing potential vandalism of power charging devices. Further, since an electric vehicle 112 may be used as distributed storage devices to stabilize a power grid, a docking-to-grid solution may be used to increase availability of vehicles for Vehicle-to-Grid (V2G) operation.

A wireless power transfer system 100 as described with reference to FIG. 1 may also provide aesthetic and non-impedimental advantages. For example, there may be no charge columns and cables that may be impedimental for vehicles or pedestrians.

As a further explanation of the vehicle-to-grid capability, the wireless power transmit and receive capabilities may be configured to be reciprocal such that the base wireless charging system 102 a transfers power to the electric vehicle 112 and the electric vehicle 112 transfers power to the base wireless charging system 102 a, e.g., in times of energy shortfall. This capability may be useful to stabilize the power distribution grid by allowing electric vehicles to contribute power to the overall distribution system in times of energy shortfall caused by over demand or shortfall in renewable energy production (e.g., wind or solar).

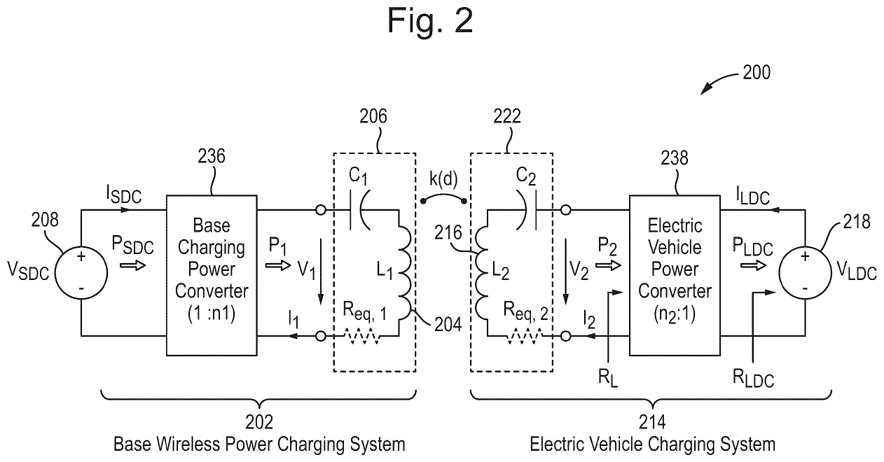

FIG. 2 is a schematic diagram of core components of the wireless power transfer system 100 of FIG. 1. As shown in FIG. 2, the wireless power transfer system 200 may include a base system transmit circuit 206 including a base system coupler 204 having an inductance L1. The wireless power transfer system 200 further includes an electric vehicle receive circuit 222 including an electric vehicle coupler 216 having an inductance L2. Implementations of the couplers described herein may use capacitively loaded wire loops (e.g., multi-turn coils) forming a resonant structure that is capable of efficiently coupling energy from a primary structure (transmitter) to a secondary structure (receiver) via a magnetic or electromagnetic near field if both primary and secondary couplers (e.g., coils) are tuned to a common resonant frequency. The coils may be used for the electric vehicle coupler 216 and the base system coupler 204. Using resonant structures for coupling energy may be referred to “magnetic coupled resonance,” “electromagnetic coupled resonance,” or “resonant induction.” The operation of the wireless power transfer system 200 will be described based on power transfer from a base wireless charging system 202 to an electric vehicle 112, but is not limited thereto. For example, as discussed above, the electric vehicle 112 may transfer power to the base wireless charging system 102 a.

With reference to FIG. 2, a power supply 208 (e.g., AC or DC) supplies power PSDC to the base wireless charging system 202 to transfer energy to an electric vehicle 112. The base wireless charging system 202 includes a base charging system power converter 236. The base charging system power converter 236 may include circuitry such as an AC/DC converter configured to convert power from standard mains AC to DC power at a suitable voltage level, and a DC/low frequency (LF) converter configured to convert DC power to power at an operating frequency suitable for wireless high power transfer. The base charging system power converter 236 supplies power P1 to the base system transmit circuit 206 including the capacitor C1 in series with the base system coupler 204 to emit an electromagnetic field at a desired frequency. The capacitor C1 may be coupled with the base system coupler 204 either in parallel or in series, or may be formed of several reactive elements in any combination of parallel or series topology. The capacitor C1 may be provided to form a resonant circuit with the base system coupler 204 that resonates at a desired frequency. The base system coupler 204 receives the power P1 and wirelessly transmits power at a level sufficient to charge or power the electric vehicle 112. For example, the power level provided wirelessly by the base system coupler 204 may be on the order of kilowatts (KW) (e.g., anywhere from 1 kW to 110 KW, higher, or lower).

The base system transmit circuit 206 including the base system coupler 204 and electric vehicle receive circuit 222 including the electric vehicle coupler 216 may be tuned to substantially the same frequencies and may be positioned within the near-field of an electromagnetic field transmitted by one of the base system coupler 204 and the electric vehicle coupler 116. In this case, the base system coupler 204 and electric vehicle coupler 116 may become coupled to one another such that power may be transferred to the electric vehicle receive circuit 222 including capacitor C2 and electric vehicle coupler 116. The capacitor C2 may be provided to form a resonant circuit with the electric vehicle coupler 216 that resonates at a desired frequency. The capacitor C2 may be coupled with the electric vehicle coupler 204 either in parallel or in series, or may be formed of several reactive elements in any combination of parallel or series topology. Element k (d) represents the mutual coupling coefficient resulting at coil separation d. Equivalent resistances Req,1 and Req,2 represent the losses that may be inherent to the couplers 204 and 216 and the anti-reactance capacitors C1 and C2. The electric vehicle receive circuit 222 including the electric vehicle coupler 316 and capacitor C2 receives power P2 and provides the power P2 to an electric vehicle power converter 238 of an electric vehicle charging system 214.

The electric vehicle power converter 238 may include, among other things, a LF/DC converter configured to convert power at an operating frequency back to DC power at a voltage level matched to the voltage level of an electric vehicle battery unit 218. The electric vehicle power converter 238 may provide the converted power PLDC to charge the electric vehicle battery unit 218. The power supply 208, base charging system power converter 236, and base system coupler 204 may be stationary and located at a variety of locations as discussed above. The battery unit 218, electric vehicle power converter 238, and electric vehicle coupler 216 may be included in an electric vehicle charging system 214 that is part of electric vehicle 112 or part of the battery pack (not shown). The electric vehicle charging system 214 may also be configured to provide power wirelessly through the electric vehicle coupler 216 to the base wireless charging system 202 to feed power back to the grid. Each of the electric vehicle coupler 216 and the base system coupler 204 may act as transmit or receive couplers based on the mode of operation.

While not shown, the wireless power transfer system 200 may include a load disconnect unit (LDU) to safely disconnect the electric vehicle battery unit 218 or the power supply 208 from the wireless power transfer system 200. For example, in case of an emergency or system failure, the LDU may be triggered to disconnect the load from the wireless power transfer system 200. The LDU may be provided in addition to a battery management system for managing charging to a battery, or it may be part of the battery management system.

Further, the electric vehicle charging system 214 may include switching circuitry (not shown) for selectively connecting and disconnecting the electric vehicle coupler 216 to the electric vehicle power converter 238. Disconnecting the electric vehicle coupler 216 may suspend charging and also may adjust the “load” as “seen” by the base wireless charging system 102 a (acting as a transmitter), which may be used to “cloak” the electric vehicle charging system 114 (acting as the receiver) from the base wireless charging system 102 a. The load changes may be detected if the transmitter includes the load sensing circuit. Accordingly, the transmitter, such as a base wireless charging system 202, may have a mechanism for determining when receivers, such as an electric vehicle charging system 114, are present in the near-field of the base system coupler 204.

As described above, in operation, assuming energy transfer towards the vehicle or battery, input power is provided from the power supply 208 such that the base system coupler 204 generates a field for providing the energy transfer. The electric vehicle coupler 216 couples to the radiated field and generates output power for storage or consumption by the electric vehicle 112. As described above, in some implementations, the base system coupler 204 and electric vehicle coupler 116 are configured according to a mutual resonant relationship such that when the resonant frequency of the electric vehicle coupler 116 and the resonant frequency of the base system coupler 204 are very close or substantially the same. Transmission losses between the base wireless charging system 202 and electric vehicle charging system 214 are minimal when the electric vehicle coupler 216 is located in the near-field of the base system coupler 204.

As stated, an efficient energy transfer occurs by coupling a large portion of the energy in the near field of a transmitting coupler to a receiving coupler rather than propagating most of the energy in an electromagnetic wave to the far-field. When in the near field, a coupling mode may be established between the transmit coupler and the receive coupler. The area around the couplers where this near field coupling may occur is referred to herein as a near field coupling mode region.

While not shown, the base charging system power converter 236 and the electric vehicle power converter 238 may both include an oscillator, a driver circuit such as a power amplifier, a filter, and a matching circuit for efficient coupling with the wireless power coupler. The oscillator may be configured to generate a desired frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance of the power conversion module to the wireless power coupler. The power converters 236 and 238 may also include a rectifier and switching circuitry to generate a suitable power output to charge the battery.

The electric vehicle coupler 216 and base system coupler 204 as described throughout the disclosed implementations may be referred to or configured as “loop” antennas, and more specifically, multi-turn loop antennas. The couplers 204 and 216 may also be referred to herein or be configured as “magnetic” antennas. The term “coupler” is intended to refer to a component that may wirelessly output or receive energy for coupling to another “coupler.” The coupler may also be referred to as an “antenna” of a type that is configured to wirelessly output or receive power. As used herein, couplers 204 and 216 are examples of “power transfer components” of a type that are configured to wirelessly output, wirelessly receive, or wirelessly relay power. Loop (e.g., multi-turn loop) antennas may be configured to include an air core or a physical core such as a ferrite core. An air core loop antenna may allow the placement of other components within the core area. Physical core antennas including ferromagnetic or ferromagnetic materials may allow development of a stronger electromagnetic field and improved coupling.

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency. Transfer of energy occurs by coupling energy from the near field of the transmitting coupler to the receiving coupler residing within a region (e.g., within a predetermined frequency range of the resonant frequency, or within a predetermined distance of the near-field region) where this near field is established rather than propagating the energy from the transmitting coupler into free space.

A resonant frequency may be based on the inductance and capacitance of a transmit circuit including a coupler (e.g., the base system coupler 204) as described above. As shown in FIG. 2, inductance may generally be the inductance of the coupler (e.g., coil), whereas, capacitance may be added to the coupler to create a resonant structure at a desired resonant frequency. As a non-limiting example, as shown in FIG. 2, a capacitor may be added in series with the coupler to create a resonant circuit (e.g., the base system transmit circuit 206) that generates an electromagnetic field. Accordingly, for larger diameter couplers, the value of capacitance needed to induce resonance may decrease as the diameter or inductance of the coupler increases. Inductance may also depend on a number of turns of a coil. Furthermore, as the diameter of the coupler increases, the efficient energy transfer area of the near field may increase. Other resonant circuits are possible. As another non limiting example, a capacitor may be placed in parallel between the two terminals of the coupler (e.g., a parallel resonant circuit). Furthermore a coupler may be designed to have a high quality (Q) factor to improve the resonance and reduce losses of the coupler. For example, the native Q factor may be 300 or greater.

As described above, according to some implementations, coupling power between two couplers that are in the near field of one another is disclosed. As described above, the near field may correspond to a region around the coupler in which electromagnetic fields exist but may not propagate or radiate away from the coupler. Near-field coupling-mode regions may correspond to a volume that is near the physical volume of the coupler, typically within a small fraction of the wavelength. According to some implementations, electromagnetic couplers, such as single and multi-turn loop antennas, are used for both transmitting and receiving since magnetic near field amplitudes in practical implementations tend to be higher for magnetic type coils in comparison to the electric near fields of an electric type antenna (e.g., a small dipole). This allows for potentially higher coupling between the pair. Furthermore, “electric” antennas (e.g., dipoles and monopoles) or a combination of magnetic and electric antennas may be used.

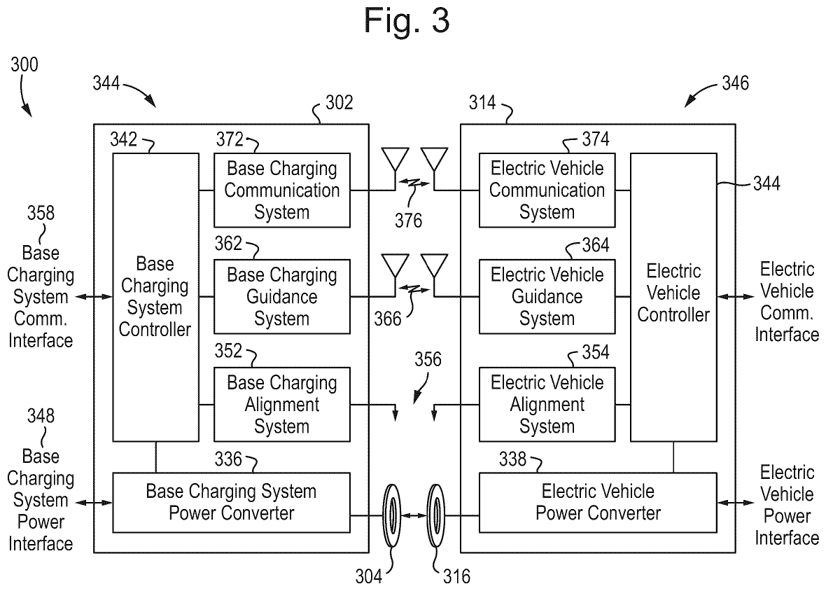

FIG. 3 is another functional block diagram showing core and ancillary components of the wireless power transfer system 100 of FIG. 1 or that wireless power transfer system 200 of FIG. 2 may be part of. The wireless power transfer system 300 illustrates a communication link 376, a guidance link 366, and alignment mechanism 356 capable of mechanically moving one or both of the base system coupler 304 and electric vehicle coupler 316 via base alignment system 352 and electric vehicle alignment systems 354. The guidance link 366 may be capable of bi-directional signaling, meaning that guidance signals may be emitted by the base guidance system 362 or the electric vehicle guidance system 364 or by both. As described above with reference to FIG. 2, and assuming energy flow towards the electric vehicle 112, in FIG. 3 a base charging system power interface 348 may be configured to provide power to a charging system power converter 336 from a power source, such as an AC or DC power supply 126. The base charging system power converter 336 may receive AC or DC power from the base charging system power interface 348 to excite the base system coupler 304 at or near its resonant frequency. The electric vehicle coupler 316, when in the near field coupling-mode region, may receive energy from the near field coupling mode region to oscillate at or near the resonant frequency. The electric vehicle power converter 338 converts the oscillating signal from the electric vehicle coupler 316 to a power signal suitable for charging a battery via the electric vehicle power interface.

The base wireless charging system 302 includes a base charging system controller 342 and the electric vehicle charging system 314 includes an electric vehicle controller 344. The base charging system controller 342 may include a base charging system communication interface 358 to other systems (not shown) such as, for example, a computer, and a power distribution center, or a smart power grid. The electric vehicle controller 344 may include an electric vehicle communication interface to other systems (not shown) such as, for example, an on-board computer on the vehicle, other battery charging controller, other electronic systems within the vehicles, and remote electronic systems.

The base charging system controller 342 and electric vehicle controller 344 may include subsystems or modules for specific application with separate communication channels. These communications channels may be separate physical channels or separate logical channels. As non-limiting examples, a base charging alignment system 352 may communicate with an electric vehicle alignment system 354 through a communication link 376 to provide a feedback mechanism for more closely aligning the base system coupler 304 and electric vehicle coupler 316, either via autonomous, mechanical (kinematic) alignment or with operator assistance. Similarly, a base charging guidance system 362 may communicate with an electric vehicle guidance system 364 through a guidance link 366 to provide a feedback mechanism to guide an operator in aligning the base system coupler 304 and electric vehicle coupler 316. In addition, there may be separate general-purpose communication links (e.g., channels) supported by base charging communication system 372 and electric vehicle communication system 374 for communicating other information between the base wireless charging system 302 and the electric vehicle charging system 314. This information may include information about electric vehicle characteristics, battery characteristics, charging status, and power capabilities of both the base wireless charging system 302 and the electric vehicle charging system 314, as well as maintenance and diagnostic data for the electric vehicle 112. These communication channels may be separate physical communication channels such as, for example, Bluetooth, Zigbee, cellular, etc.

Electric vehicle controller 344 may also include a battery management system (BMS) (not shown) that manages charge and discharge of the electric vehicle principal battery, a parking assistance system based on microwave or ultrasonic radar principles, a brake system configured to perform a semi-automatic parking operation, and a steering wheel servo system configured to assist with a largely automated parking ‘park by wire’ that may provide higher parking accuracy, thus reducing the need for mechanical horizontal coupler alignment in any of the base wireless charging system 102 a and the electric vehicle charging system 114. Further, electric vehicle controller 344 may be configured to communicate with electronics of the electric vehicle 112. For example, electric vehicle controller 344 may be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), and audio input devices (e.g., microphone with electronic voice recognition).

Furthermore, the wireless power transfer system 300 may include detection and sensor systems. For example, the wireless power transfer system 300 may include sensors for use with systems to properly guide the driver or the vehicle to the charging spot, sensors to mutually align the couplers with the required separation/coupling, sensors to detect objects that may obstruct the electric vehicle coupler 316 from moving to a particular height or position to achieve coupling, and safety sensors for use with systems to perform a reliable, damage free, and safe operation of the system. For example, a safety sensor may include a sensor for detection of presence of animals or children approaching the wireless power couplers 104 a, 116 beyond a safety radius, detection of objects near the base system coupler 304 that may be heated up (induction heating), detection of hazardous events such as incandescent Objects on the base system coupler 304, and temperature monitoring of the base wireless charging system 302 and electric vehicle charging system 314 components.

The wireless power transfer system 300 may also support plug-in charging via a wired connection. A wired charge port may integrate the outputs of the two different chargers prior to transferring power to or from the electric vehicle 112. Switching circuits may provide the functionality as needed to support both wireless charging and charging via a wired charge port.

To communicate between a base wireless charging system 302 and an electric vehicle charging system 314, the wireless power transfer system 300 may use both in-band signaling or out-of-band signaling. Out-of-band communication may be carried out using an RF data modem (e.g., Ethernet over radio in an unlicensed band). The out-of-band communication may provide sufficient bandwidth for the allocation of value-add services to the vehicle user/owner. A low depth amplitude or phase modulation of the wireless power carrier may serve as an in-band signaling system with minimal interference.

In addition, some communication may be performed via the wireless power link without using specific communications antennas. For example, the wireless power couplers 304 and 316 may also be configured to act as wireless communication transmitters. Thus, some implementations of the base wireless charging system 302 may include a controller (not shown) for enabling keying type protocol on the wireless power path. By keying the transmit power level (amplitude shift keying) at predefined intervals with a predefined protocol, the receiver may detect a serial communication from the transmitter. The base charging system power converter 336 may include a load sensing circuit (not shown) for detecting the presence or absence of active electric vehicle receivers in the vicinity of the near field generated by the base system coupler 304. By way of example, a load sensing circuit monitors the current flowing to the power amplifier, which is affected by the presence or absence of active receivers in the vicinity of the near field generated by base system coupler 104 a. Detection of changes to the loading on the power amplifier may be monitored by the base charging system controller 342 for use in determining whether to enable the oscillator for transmitting energy, to communicate with an active receiver, or a combination thereof.

To enable wireless high power transfer, some implementations may be configured to transfer power at a frequency in the range from 20-150 kHz. This low operating frequency may allow highly efficient power conversion that may be achieved using solid state devices. In addition, there may be less coexistence issues with radio systems compared to other bands.

With respect to induction charging, depending on the energy transfer rate (power level), operating frequency, size and design of the primary and secondary magnetic structures and the distance between them, the flux density in the air gap at some locations may exceed 0.5 mT and may reach several milliTesla. If an object that includes a certain amount of conductive material (e.g., such as metal) is inserted into the space between the primary and secondary structures, eddy currents are generated in this object (Faraday's and Lenz's law), that may lead to power dissipation and subsequent heating effects. This induction heating effect depends on the magnetic flux density, the frequency of the time-varying magnetic field (e.g., an alternating magnetic field), and the size, shape, orientation and conductivity of the object's conducting structure. When the object is exposed to the magnetic field for a sufficiently long time, it may heat up to temperatures that may be considered hazardous in several regards. One hazard may be self-ignition if the object includes inflammable materials or if it is in direct contact with such materials, e.g., a cigarette package including a thin metallic foil or metallic film. Another hazard may be burning the hand of a person that may pick-up such a hot object, e.g., a coin or a key. Another hazard may be damaging the plastic enclosure of the primary or secondary structure, e.g., an object melting into the plastic.

A temperature increase may be also expected in objects including ferromagnetic materials that may be substantially non-conducting but exhibiting a pronounced hysteresis effect or in materials that generate both hysteresis and eddy current losses. As such, detecting such objects is beneficial to avoid corresponding harmful consequences. If the object detection system is integrated within a system for providing wireless power, in response to detecting a harmful object, the system may reduce a power level or shut down until measures may be taken to remove the harmful object. Sensing objects based on their changing temperature inductively may be called “inductive thermal sensing.”

In certain applications of inductive power transfer such as charging of electric vehicles in domestic and public zones, it may be compulsory for reasons of safety of persons and equipment to be able to detect foreign objects that have the potential to heat up to critical temperatures. This may be particularly true in systems where the critical space is open and accessible such that foreign objects may get accidentally or intentionally placed in this space (e.g., in case of sabotage).

Implementations described herein are directed to automatically detecting hazardous ferromagnetic foreign objects (e.g., metal objects including ferromagnetic materials) that may be located in a predetermined space. In particular, certain implementations are directed to detecting small metal objects (e.g., a coin) located adjacent to a surface of the primary or secondary magnetic structure where magnetic flux density may exceed a particular value (e.g., 0.5 mT).

The methods and concepts disclosed herein enable inductive detection of objects of another category of foreign metallic objects that change some electromagnetic properties or electrical characteristics instantaneously upon exposing the object to a biasing magnetic field. Such magnetic biasing effects can be observed in ferromagnetic materials e.g. iron, steel but also in ferrites (e.g. soft ferrites).

Metallic objects containing ferromagnetic materials are a potential hazard as they may heat up to critical temperatures when exposed to an alternating magnetic field at a level that is typically produced inside the functional space of a Wireless Power Transfer (WPT) system. This may be particularly true for lengthy objects if oriented with their long side (easy axis of magnetization) in the direction of the WPT magnetic field. Detecting ferromagnetic metallic objects is therefore of particular importance. Many objects used in daily life such as tools, screws, nuts, washers, nails, paper clips, etc. belong to this category. Some objects of this category may also fall into the category of objects that heat up rapidly and whose electrical conductivity or magnetic permeability also change substantially as the object's temperature increases or decreases.

Most of the means and functions used for ordinary inductive sensing of metallic (electrically conductive) objects may also apply to the methods and concepts disclosed herein for the detection of ferromagnetic metallic objects. Therefore, these methods and concepts should be construed as another additive feature of an enhanced metal object detection apparatus, not necessarily requiring a separate, additional apparatus.

Sensors and other parts of the foreign object detection systems disclosed herein are conceived to be integrated into a WPT coupler (WPT pad) and, in particular, into the WPT base coupler (base pad). However, the principal methods and concepts disclosed herein may also apply to a vehicle coupler (vehicle pad) integration and also to non-integrated stand-alone (discrete) solutions. The WPT coupler may be one of a so-called “circular”-type coupler (using a “circular” coil), a “Double D”-type coupler (using a double coil arrangement), a “Solenoid”-type coupler (using a solenoid coil wound around a core), a “Bi-polar”-type coupler (using a double coil arrangement with virtually zero coupling between coils) or any other type of coupler based on a single or multi-coil arrangement. A WPT coupler may be composed of a planar coil structure (e.g. made of a Copper Litz wire), a planar ferrite structure (e.g. soft ferrite material) backing the coil, and a conductive back plate (e.g. made of aluminum) disposed on a surface of the planar ferrite structure opposite to the surface of the coil.

Descriptions and drawings herein assume a single ferromagnetic foreign object for the sake of simplicity. However, methods and apparatuses disclosed herein generally have the potential to detect an abnormal state due to the presence of more than one ferromagnetic foreign object within a predetermined space.

Electrically conductive and ferromagnetic objects exposed to a low frequency alternating magnetic field, e.g. a WPT magnetic field in the range from 20 to 150 kHz with a flux density in the order of 1 mT or above, may heat up to hazardous temperatures, e.g., above 500 K. This is particularly true for lengthy ferromagnetic objects if their longer axis is substantially oriented in a direction of the magnetic field. Objects with temperatures greater than 500 K may be considered for potential of fire if the object comes in contact with a flammable material such as paper, dry foliage, oil, fuel, etc. Therefore, such objects must be considered a safety issue for a WPT system generating magnetic flux density levels in the milliTesla (mT) range in its functional space, if open and accessible. If laying directly on the surface of a base pad, such hot objects may also cause damage since they could melt or burn the plastic enclosure.

The presence of a ferromagnetic (e.g., metallic) object in a predetermined space can be detected inductively by measuring at least one electrical characteristic (e.g., an equivalent inductance, an equivalent resistance, a frequency response, or an impulse response) at the terminals of at least one loop of an electrical conductor, herein called an inductive sensing coil. A ferromagnetic object of sufficient size that is sufficiently close to an inductive sensing coil will alter the sensing magnetic field as generated by that inductive sensing coil so as to exert a measurable impact on one or more of the above-mentioned electrical characteristics. Furthermore, in some implementations, a ferromagnetic object may be detected by comparing a measured sample of at least one of the above-mentioned electrical characteristics with a reference sample of that same at least one characteristic. Such a reference sample may have been obtained in a process of calibration in absence of any ferromagnetic foreign object, for example.

However, for increased detection sensitivity requirements, and in certain use cases, this basic approach may not provide a reliable foreign object detection solution. For example, if other metallic or magnetic structures are located in the sensing range of the foreign object detection system and are not stationary, the structures' effects on the characteristics of the inductive sense coil will also dynamically change. Thus, a simple calibration process cannot nullify the effects of such other metallic structures. In a ground-to-vehicle inductive charging application with a foreign object detection integrated into the base pad, such a disturbing structure may include the vehicle WPT coupler or the vehicle's underbody. In addition, electrically conductive or magnetic structures in the base pad may also exert a variable measurable effect on one the characteristics of one or more inductive sensing coils. Such effects may be due to, e.g., small movements caused by mechanical stress, varying temperature, or changes in the electrical or magnetic properties of these structures as a consequence of a changing temperature or magnetic field, for example. Moreover, electrical characteristics of such an inductive sense coil itself may change due to mechanical stress, temperature effects, or changes in the electric properties of the surrounding insulating materials, resulting in a change of the inductive sense coil's self-capacitance or ground capacitance. The effects of a changing environment may be manageable in a system designed for detecting metallic objects located near a surface (essentially in a two-dimensional space), but they may be focus of improvement in a foreign object detection system designed for increased sensitivity, e.g., for detecting metal objects in an extended (three-dimensional) space.

Ferromagnetic metallic (e.g., conductive) objects can potentially be detected inductively, e.g., in the MHz frequency range, through an instantaneous change of one or more characteristics (e.g., equivalent inductance or equivalent resistance) of an inductive sense coil that occurs when exposed to a strong enough static biasing magnetic field. It appears that the electrical conductivity, and generally also the magnetic permeability, of a ferromagnetic object instantaneously changes when exposed to the biasing static magnetic field. The biasing static magnetic field may be considered to exert a biasing effect on the electromagnetic material properties of the ferromagnetic object. This effect is typically relatively weak for most ferromagnetic metallic objects that are subjected to a static biasing magnetic field. This relatively weak effect can be explained by a known magneto-impedance effect of ferromagnetic objects.

However, the impact on an equivalent inductance or an equivalent resistance of the inductive sense coil is several orders of magnitude larger (e.g., 100 to 1000 times larger) than what could be explained by the above-described magneto-impedance effect when the ferromagnetic object is exposed to a biasing low-frequency time-varying magnetic field (e.g., alternating magnetic field). This comparatively strong effect cannot be explained by the ordinary magneto-impedance effect, as may apply to static biasing magnetic fields. For some implementations of WPT, a biasing alternating magnetic field may be the low-frequency alternating magnetic field as generated for power transfer, thus eliminating the need for an auxiliary biasing alternating magnetic field. In other implementations, the biasing alternating magnetic field may be a different alternating magnetic field from that used for power transfer.

Exposing ferromagnetic objects to the WPT magnetic field generally modulates the object's apparent electrical conductivity and magnetic permeability, which may, in turn, result in a modulation of the equivalent resistance or equivalent inductance as measured at the terminals of the inductive sense coil at sense frequencies. Depending on the impact of the ferromagnetic object on the equivalent inductance or resistance of the sense coil, this low frequency modulation may be of a very small degree, e.g., less than 1%.

In some implementations, the modulating effect on the apparent conductivity and permeability of the ferromagnetic object may also be accompanied by a Joule heating effect due to eddy current or hysteresis losses within the skin depth of the ferromagnetic object caused by the biasing alternating magnetic field. The Joule heating effect will increase the temperature of the ferromagnetic object and will consequently also alter the apparent electrical conductivity and magnetic permeability of the ferromagnetic object, depending on the temperature coefficient of the ferromagnetic object.

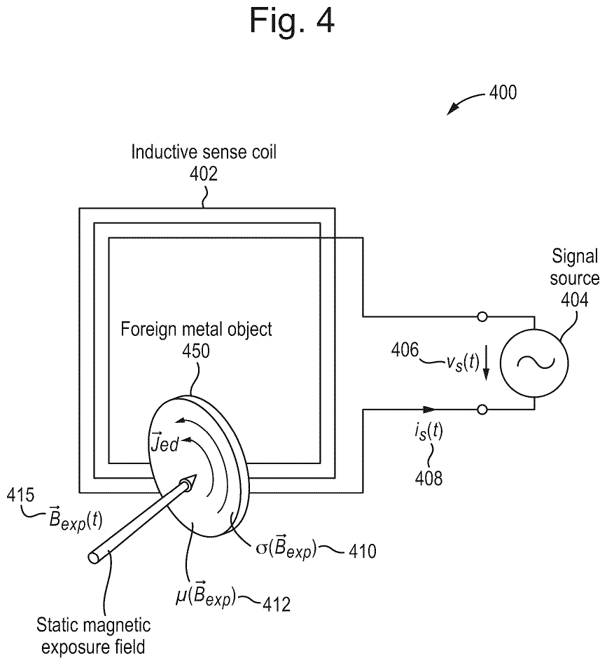

FIG. 4 is a diagram of a simplified circuit 400 for detecting a ferromagnetic foreign object (e.g., foreign object 450) using an inductive sensing coil 402 where the object's electrical conductivity and magnetic permeability are a function of exposure to a biasing static magnetic field 415, in accordance with some implementations. The circuit 400 includes the inductive sensing coil 402, which may comprise a coil of one or more loops and a foreign object 450 exposed to a static magnetic field \vec{B}exp(t) 415. The inductive sensing coil 402 may be excited by a sinusoidal signal source 404 at a voltage vₛ(t) 406 and a sense frequency (fₛ) resulting in a sense current iₛ(t) 408. The static magnetic field \vec{B}ₑₓₚ(t) 415 magnetically biases the foreign object 450. The foreign object's 450 electrical conductivity σ(\vec{B}ₑₓₚ) 410 and magnetic permeability μ(\vec{B}ₑₓₚ) 412 as apparent through inductive sensing are generally functions of the biasing static magnetic field \vec{B}ₑₓₚ. Since equivalent inductance and resistance are functions of σ(\vec{B}ₑₓₚ) and μ(\vec{B}ₑₓₚ), a presence of the foreign object 450 can be potentially detected by analyzing current iₛ(t) in relation to source voltage vₛ(t) 515 and the strength of the static magnetic field \vec{B}ₑₓₚ.

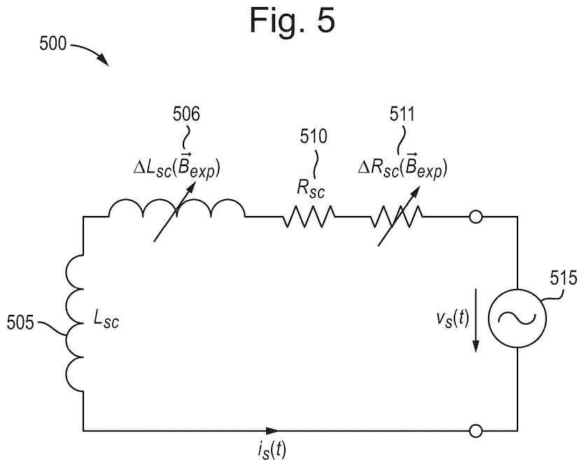

FIG. 5 is an equivalent circuit diagram 500 of the simplified circuit 400 for detecting the foreign object 450 of FIG. 4. The equivalent series circuit 500 may be applicable to a steady state of a sinusoidal excitation of an inductive sensing coil (e.g., sense coil 402 of FIG. 4) by a voltage vₛ(t) having frequency fₛ, which induces a current is (t) to circulate in the circuit 500. The equivalent series circuit 500 comprises a series inductance L_{sc} 505 representing the system's overall energy storage effect and a series resistance R_{sc} 510 representing the system's overall loss effects. The equivalent series circuit 500 also comprises differential inductance ΔL_{sc}(\vec{B}ₑₓₚ) 506 and differential resistance ΔR_{sc}(\vec{B}ₑₓₚ) 511, which represent the inductive and resistive effects, respectively, exerted by a ferromagnetic object (e.g., the foreign object 450 of FIG. 4) in the influence zone of the inductive sense coil (e.g., the inductive sense coil 402 of FIG. 4). Differential inductance ΔL_{sc}(\vec{B}ₑₓₚ) 506 and differential resistance ΔR_{sc}(\vec{B}ₑₓₚ) 511 of the foreign object 450 are affected instantaneously when the object is exposed to the biasing static magnetic field \vec{B}ₑₓₚ.

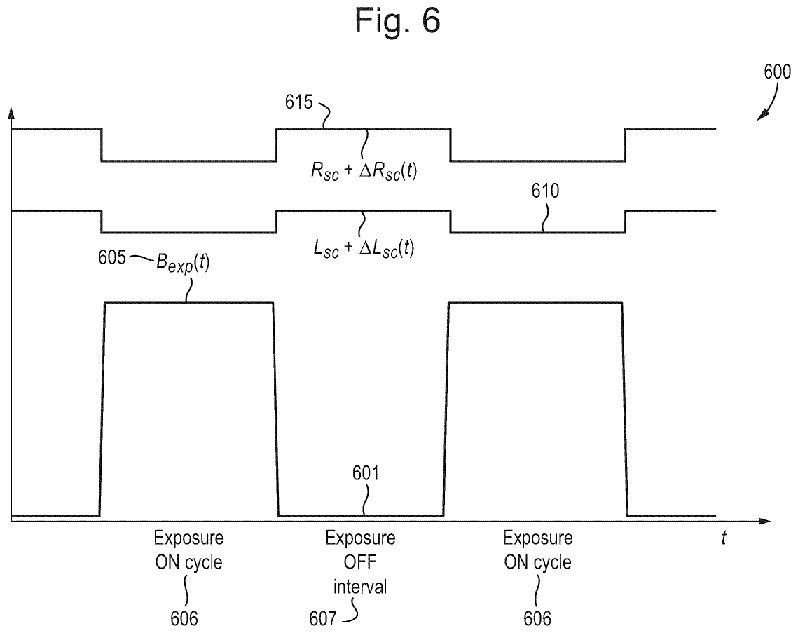

FIG. 6 is a time diagram 600 illustrating an effect of intermittent exposure of a ferromagnetic foreign object to a static magnetic field \vec{B}ₑₓₚ on characteristics of the inductive sense coil (e.g., the inductive sense coil 402 of FIG. 4), in accordance with some implementations. As shown in FIG. 6, a foreign object (e.g., foreign object 450 of FIG. 4) is intermittently exposed to the static biasing magnetic field \vec{B}ₑₓₚ. The detection method is based on “stimulated” inductive impedance and resistance sensing where at a minimum, stimulation may comprise at least one exposure ON interval 606 followed by an exposure OFF interval 607. FIG. 6 shows this toggling of the static magnetic field \vec{B}ₑₓₚ according to line 601. FIG. 6 additionally shows the resulting time variations of sense coil's equivalent inductance L_{sc}+ΔL_{sc}(t) 610 and equivalent resistance R_{sc}+ΔR_{sc}(t) 615. As shown, and according to the known magneto-impedance effect, both the equivalent inductance L_{sc}+ΔL_{sc}(t) 610 and the equivalent resistance R_{sc}+ΔR_{sc}(t) 615 decrease during the exposure ON intervals 606 and increase during the exposure OFF interval 607. These characteristic variations may reveal the presence of a ferromagnetic foreign object.

For example, in an implementation, at least one of an inductive sense coil 402's characteristics e.g., an equivalent resistance R_{sc}+ΔR_{sc}(t) 615, is measured constantly and recorded over a time period of at least a fraction of an exposure interval (e.g., ON interval 606 and OFF interval 607) including the start. To determine a presence of a foreign object 450, in some implementations, the at least one recorded time course of resistance R_{sc}+ΔR_{sc}(t) 615 is compared with the exposure time profile 601 for B̅ₑ̅ₓ̅ₚ̅(t) 605. In some other implementations, this comparison is a correlation. The recorded time course of resistance R_{sc}+ΔR_{sc}(t) 615 or other sense coil 402 characteristic is correlated with the exposure time profile 601 for B̅ₑ̅ₓ̅ₚ̅(t) 605. In a further implementation, correlation is performed with at least one of a time-derivative, e.g., the first derivative d/dt (the time gradient) of the recorded time course of at least one of an inductive sense coil 402's characteristics.

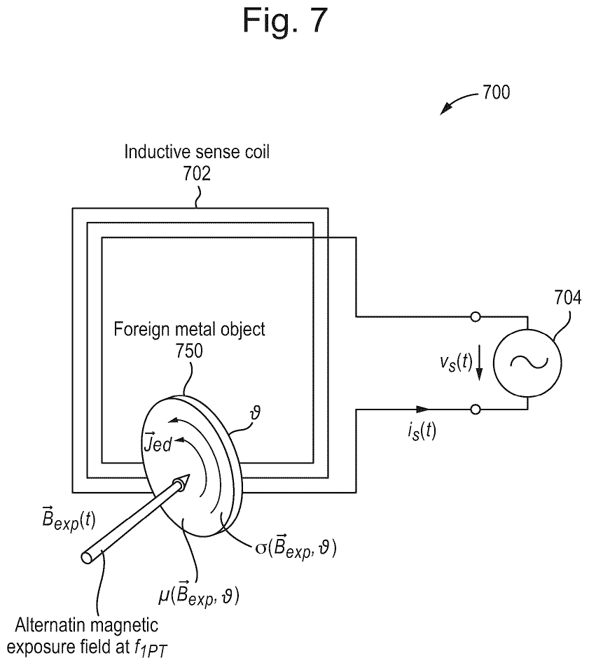

FIG. 7 is a diagram of a simplified circuit 700 for detecting a ferromagnetic foreign object (e.g., foreign object 750) using an inductive sensing coil 702 where the object's electrical conductivity α(\vec{B}ₑₓₚ, ϑ) and magnetic permeability ϑ(\vec{B}ₑₓₚ, ϑ), are a function of exposure to a biasing time-varying magnetic field \vec{B}ₑₓₚ(t), in accordance with some implementations. In some implementations, the biasing time-varying (e.g., alternating) magnetic field \vec{B}ₑₓₚ(t) may be the WPT low frequency magnetic field. In such cases, means for generating a second time-varying magnetic field may comprise one or more WPT transmit coils. The alternating magnetic field \vec{B}ₑₓₚ(t) may alternate with a frequency f_{IPT}. As with the static magnetic field previously described in connection with FIG. 4, the foreign object's 750 apparent electrical conductivity σ(\vec{B}ₑₓₚ, ϑ) and magnetic permeability μ(\vec{B}ₑₓₚ, ϑ) vary in some relationship to the alternating exposure field \vec{B}ₑₓₚ(t), so as to modulate current iₛ(t), which is driven by the voltage vₛ(t) provided by the voltage source 704. However, as the notation shows, σ(\vec{B}ₑₓₚ, ϑ) and μ(\vec{B}ₑₓₚ, ϑ) are normally also functions of the object's temperature ϑ, and are thus also indirectly affected by the biasing alternating magnetic field \vec{B}ₑₓₚ(t) via the Joule heating effect. However, testing with many different objects has shown that this Joule heating effect is generally much weaker than the modulating effect due to exposure to the biasing alternating magnetic field, and changes due to the Joule heating effects are also orders of magnitude slower than the nearly instantaneous changes due to this novel modulating effect, depending on the thermal capacity of the foreign object 750 and the heating power. The presence of the foreign object 750 can potentially be detected by analyzing the current iₛ(t) in relation to source voltage vₛ(t) and to the exposure field signal \vec{B}ₑₓₚ(t) by this modulating effect and, in some cases, also by the thermal effect.

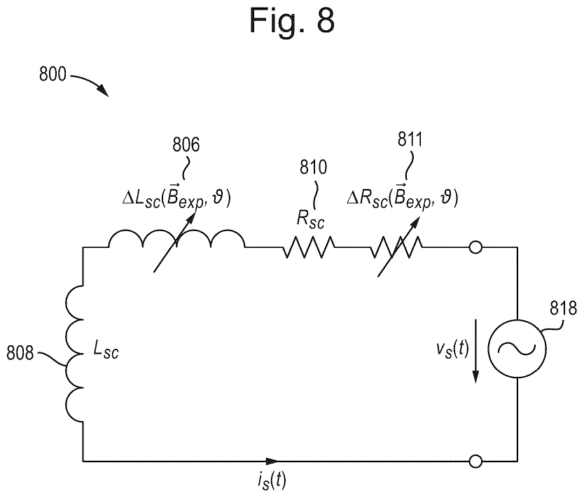

FIG. 8 is an equivalent circuit 800 diagram of the simplified circuit 700 for detecting the foreign object 750 of FIG. 7. The equivalent circuit 800 of FIG. 8 comprises a voltage source 818 providing a voltage vₛ(t), which drives a current iₛ(t) through a series connection of an equivalent inductance L_{sc} 808, an equivalent series resistance R_{sc} 810, and the portions of the equivalent inductance ΔL_{sc}(\vec{B}ₑₓₚ, ϑ) 806 and of the equivalent resistance ΔR_{sc}(\vec{B}ₑₓₚ, ϑ) 811 that can be attributed to the presence of the foreign object 750 and that are generally affected by both the modulating and the thermal effects when exposed to the alternating magnetic field \vec{B}ₑₓₚ(t).

Other examples of foreign object detection systems will be appreciated which implement a continuous waveform response approach or an impulse response approach, such as that described in US 2019/0293829 which is incorporated herein by reference in its entirety.

### Example Method for Improving a Calculation of a Missed Foreign Object Detection (FOD) Probability in an Inductive Wireless Power Transfer (WPT) System

A foreign object detection system may be implemented as described herein. In the foreign object detection system, a detection of a foreign object by the system may occur following the detection of an object response measurement, r. The object response measurement, r, may be any suitable measurement as described herein. During normal use of an inductive wireless power transfer system employing such a foreign object detection system, there may exist a baseline level of noise in the object response measurement, r, caused by unrelated transient events (such as a car oscillating due to wind or a passenger entering or leaving the car, among others which will be appreciated). This baseline level of noise may result in a false positive detection. Therefore, the object response measurement, r, may only result in an object detection when the object response measurement, r, is greater than a detection threshold, t.

In some cases, said baseline level of noise may have less of an effect on object detections which are sensed by more than one object detection sensor in the foreign object detection system. In such cases, a lower detection threshold may be required in order for an object response measurement to result in an object detection. The detection threshold, t, may therefore in some cases be dependent on the number of object detection sensors at which an object response is observed, and may in particular be directly correlated with the number of object detection sensors indicating the presence of a foreign object. The object detection threshold may therefore be dynamically calculated from a range of object detection thresholds, ranging between a minimum detection threshold, tₘᵢₙ, and a maximum detection threshold, tₘₐₓ. This preferably provides a dynamic detection threshold which is more robust against false positive detections while also reducing probability of missed detections.

It will be appreciated that the object response measurements are intended to have no lower bound, and can be as low as zero, but in some embodiments there may a low-level noise floor which may be application dependent.

Even when implementing a dynamic object detection threshold as discussed herein to mitigate false positive detection rate and missed detections, various scenarios occurring during normal use can potentially affect missed detection rate. It may therefore be important to identify missed detection rate of a system in various scenarios constituting normal use of an inductive wireless power transfer system.

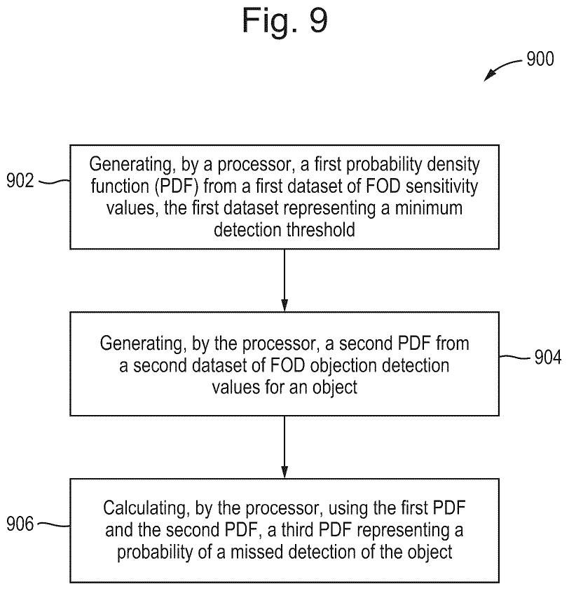

The present disclosure therefore provides a method for improving a calculation of a missed foreign object detection probability in an inductive wireless power transfer system. An example method 900 in accordance with the present disclosure is shown in FIG. 9. In the example 900 shown, the method 900 comprises: generating, by a processor, a first probability distribution function (PDF) from a first dataset of FOD sensitivity values, the first dataset representing a minimum detection threshold 902; generating, by the processor, a second PDF from a second dataset of FOD object detection values for an object 904; calculating, by the processor, using the first PDF and the second PDF, a third PDF representing a probability of a missed detection of the object 906.

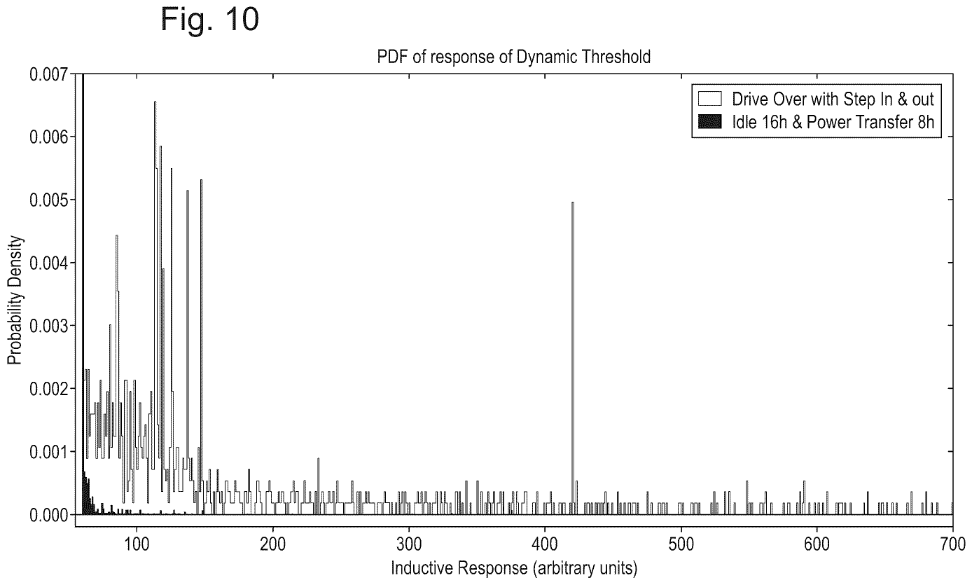

Example first PDFs are depicted in FIG. 10. The example first PDFs shown in FIG. 10 each depict a probability density function of inductive response measurements detected by a FOD system of an inductive WPT system such as that substantially as described herein, collected over a period of normal use of the inductive WPT system in one of two scenarios in the absence of a foreign object. Thereby the inductive response measurements used in the generation of the first PDFs shown may be considered to represent baseline sensitivity values of the FOD system. In a first scenario (labelled “Drive Over with Step In & Out”), the inductive WPT system was operational throughout the scenario, during which a series of instances (15 in total) occurred of a driver positioning an electric vehicle over the charging pad of the inductive WPT system to be charged, followed by the driver exiting the vehicle in the normal manner, before stepping back into the vehicle and driving the electric vehicle away from the charging pad. In a second scenario (labelled “Idle 16h & Power Transfer 8 h”) the same inductive WPT system was in idle (the FOD system running but with the WPT system not transferring power) for a period of 16 hours following by a period of operational power transfer for 8 hours in the presence of a vehicle. The first PDF FIG. 10 may therefore be considered to represent a baseline inductive response profile for a WPT system in normal use and in the absence of foreign objects within or proximate the charging field of the WPT system. Raw inductive response measurements were converted into time-differential response measurements. A histogram was constructed by assigning the converted responses to bins. The histogram data were normalized by the total number of samples to create the first PDF of the detection threshold. The inductive response measurements used in the generation of the first PDFs can be any suitable inductive response measurement as described herein. In this particular case, the inductive response measurement used was the dynamic threshold as calculated and reported by the FOD system.

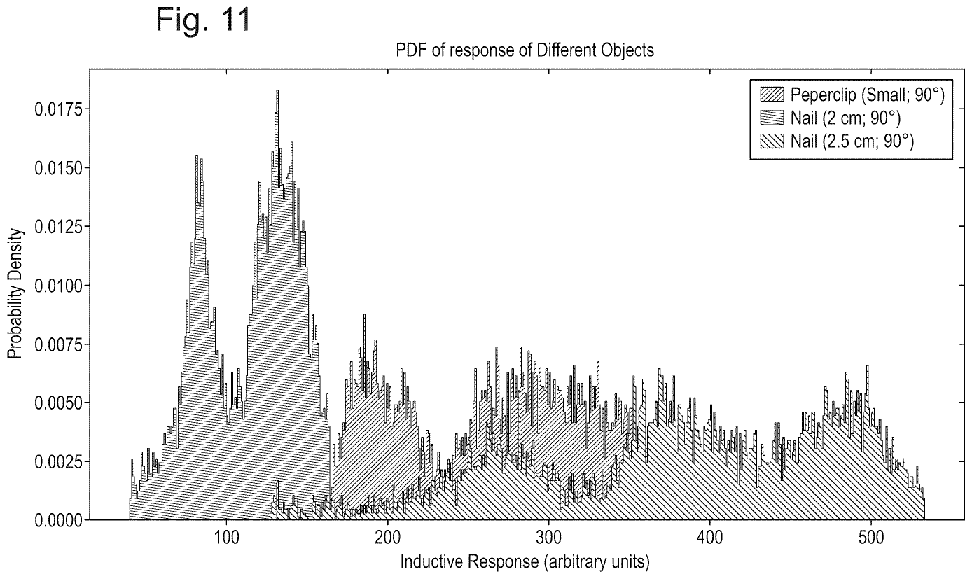

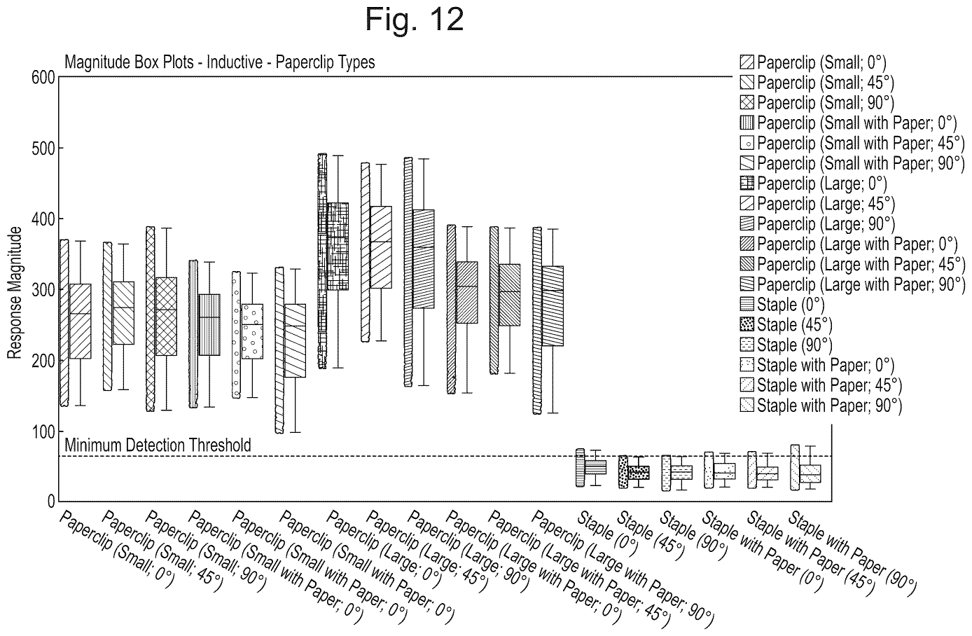

Examples of second PDFs are depicted in FIG. 11 and FIG. 12. The example second PDFs shown in FIG. 11 and FIG. 12 each depict a probability density function of inductive response measurements detected by a FOD system of an inductive WPT system used for FIG. 10, collected in the presence of a corresponding known foreign object in a particular orientation relative to a symmetry axis that passes through the centerline of the charging pad. FIG. 11 shows the full PDF for three example known foreign objects. FIG. 12 shows simplified PDFs with the addition of box plots for a variety of objects and orientations. In particular, for each known foreign object (including a standard large paperclip, with and without paper; a standard small paperclip, with and without paper) a positioning robot was used to hold each object on a horizontal plane proximate the charging pad of the inductive WPT system, and at an angle (0°, 45° or) 90° relative to a centerline of the pad, and to move each known foreign object along a predefined path across the charging pad. In this example the predefined path ensured at least five line scans of each object detection sensor of the FOD system (which contains a plurality of such sensors). Further in this example, the path included a plurality of special regions of interest, which have a differentiated response to a foreign object, including the corners and edges of the charging pad. Raw inductive response measurements were converted into time-differential response measurements. A histogram was constructed by assigning the converted responses to bins. The histogram data were normalized by the total number of samples to create the first PDF of the detection threshold. The inductive response measurements used in the generation of the first PDFs can be any suitable inductive response measurement as described herein. In this particular case, the inductive response measurements were maximum reported inductive responses across all sensor loops, at each time step of the scan.

After the first and second PDFs are constructed, the presently disclosed method comprises calculating a third PDF representing a probability that the foreign object response distribution (such as that shown in the second PDFs of FIG. 11 and FIG. 12) is lower than the detection threshold distribution (such as that shown in the first PDF of FIG. 10). The third PDF may then be summed across regions of interest to produce a final probability number representative of a missed detection probability.

An example determination of a missed detection probability for a specific test object, in a specific use-case scenario, can be described as:
for each observed detection threshold, the probability is multiplied with the probabilities that the foreign object responses are lower than that threshold;
this process is repeated for all observed detection thresholds, which are then summed, yielding a missed detection probability for the specific use-case scenario to which the first PDF belongs to.

In analytical terms, and since the r<t event is independent of the t=t₀ event (for objects small enough to not change the dynamic threshold), we have that:

$${P}_{Missed} = {\sum }_{{t}_{0} = {t}_{m i n}}^{{t}_{ma x}} P ( r < t ⋂ t = {t}_{0} ) = {\sum }_{{t}_{0} = {t}_{m i n}}^{{t}_{m ax}} P ( r < {t}_{0} ) P ( t = {t}_{0} ) = {\sum }_{{t}_{0} = {t}_{m i n}}^{{t}_{m ax}} {φ}_{T} [ {t}_{0} ] P ( r < {t}_{0} )$$

Since P (r<t₀) is simply the integration of φ_{R} [r] from rₘᵢₙ to t₀, we get:

$${P}_{Missed} = {\sum }_{{t}_{0} = {t}_{m i n}}^{{t}_{m ax}} ( {φ}_{T} [ {t}_{0} ] \cdot {\sum }_{r = {r}_{m i n}}^{t 0} {φ}_{R} [ r ] )$$

And replacing k=t₀−tₘᵢₙ, we finally get:

$${P}_{Missed} = {\sum }_{k = 0}^{{t}_{m ax} - {t}_{m i n}} ( {φ}_{T} [ {t}_{m i n} + k ] \cdot {\sum }_{r = {r}_{m i n}}^{{r}_{m i n} + k} {φ}_{R} [ r ] )$$

Example missed detection probabilities for each known foreign object represented in FIG. 11 are shown in Table 1. Additional example missed detection probabilities for further known foreign objects (1 Euro Cent coin; 5 Euro Cent coin; a 2 cm Nail as represented in FIG. 11; a 2.5 cm Nail as represented in FIG. 11; and a Steel Wool Lump) are shown in Table 2.

TABLE 1

| | Drive Over | |
|---|---|---|
| | with Step | Idle for 16 h & Power |
| Object | In & Out | Transfer for 8 h |
| Paperclip (Large; 0°) | 35.01745% | 0.040005% |
| Paperclip (Large; 45°) | 35.03886% | 0.040135% |
| Paperclip (Large; 90°) | 35.30238% | 0.041616% |
| Paperclip (Large; With Paper; 0°) | 36.02652% | 0.047762% |
| Paperclip (Large; With Paper; 45°) | 36.06245% | 0.048078% |
| Paperclip (Large; With Paper; 90°) | 36.34977% | 0.049626% |
| Paperclip (Small; 0°) | 36.70698% | 0.051919% |
| Paperclip (Small; 45°) | 36.55409% | 0.05099% |
| Paperclip (Small; 90°) | 36.62465% | 0.051228% |
| Paperclip (Small; With Paper; 0°) | 36.75705% | 0.052614% |
| Paperclip (Small; With Paper; 45°) | 36.87654% | 0.053434% |
| Paperclip (Small; With Paper; 90°) | 37.35666% | 0.055781% |

TABLE 2

| | Drive Over | |
|---|---|---|
| | with Step | Idle for 16 h & Power |
| Object | In & Out | Transfer for 8 h |
| Coin (1 Euro Cent) | 21.06853% | 0.005724% |
| Coin (5 Euro Cent) | 17.93036% | 0.003113% |
| Nail (2 cm; 0°) | 44.16035% | 1.071704% |
| Nail (2 cm; 45°) | 43.61482% | 0.101854% |
| Nail (2 cm; 90°) | 46.02449% | 4.241446% |
| Nail (2.5 cm; 0°) | 34.95814% | 0.038912% |
| Nail (2.5 cm; 45°) | 34.80801% | 0.0387% |
| Nail (2.5 cm; 90°) | 34.88483% | 0.03931% |
| Steel Wool (Lump) | 26.1886% | 0.012877% |

The present disclosure can be further understood with reference to the following paragraphs:

The disclosures of the Applicant's earlier applications are hereby expressly incorporated in their entireties by reference herein.

For example, from US 2019/293829 being expressly incorporated in its entirety by reference herein, remote systems, such as vehicles, have been introduced that include locomotion power derived from electricity received from an energy storage device such as a battery. Such energy storage devices need to be periodically charged. For example, hybrid electric vehicles include on-board chargers that use power from vehicle braking and traditional motors to charge the vehicles. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless charging systems that are capable of transferring power in free space (e.g., via an electromagnetic field) to be used to charge electric vehicles may overcome some of the deficiencies of wired charging solutions. However, using electromagnetic fields may induce eddy currents in a well conducting (e.g., metallic or ferromagnetic) object located within the field, potentially causing the object to heat up, vibrate or cause a nearby object to melt or catch fire. As such, wireless charging systems and methods that efficiently and safely transfer power for charging electric vehicles are desirable.

Discussed herein is an apparatus for detecting an object. The apparatus comprises an inductive sensing coil that is configurable to generate a first magnetic field. The inductive sensing coil is configured to have an electrical characteristic that is detectable when generating the first magnetic field. The electrical characteristic is configured to vary as a function of a second time-varying magnetic field simultaneously applied to the object. The apparatus further comprises a controller configured to detect a change in the electrical characteristic and determine a presence of the object based on the detected change in the electrical characteristic.

Also discussed herein is an implementation of a method for detecting a presence of an object. The method comprises detecting a change in an electrical characteristic of an inductive sensing coil, wherein the electrical characteristic is detectable when the inductive sensing coil generates a first magnetic field and the electrical characteristic is configured to vary as a function of a second time-varying magnetic field simultaneously applied to the object. The method further comprises determining a presence of the object based on the detected change in the electrical characteristic.

Also discussed herein is a non-transitory, computer-readable medium comprising code that, when executed, causes an apparatus for detecting an object to detect a change in an electrical characteristic of an inductive sensing coil, wherein the electrical characteristic is detectable when the inductive sensing coil generates a first magnetic field and the electrical characteristic is configured to vary as a function of a second time-varying magnetic field simultaneously applied to the object. The code, when executed, further causes the apparatus to determine a presence of the object based on the detected change in the electrical characteristic.

Also discussed herein is an apparatus for detecting a presence of an object. The apparatus comprises means for detecting a change in an electrical characteristic of an inductive sensing coil, wherein the electrical characteristic is detectable when the inductive sensing coil generates a first magnetic field and the electrical characteristic is configured to vary as a function of a second time-varying magnetic field simultaneously applied to the object. The apparatus further comprises means for determining a presence of the object based on the detected change in the electrical characteristic.

As and additional example, from US 2021/124078 being expressly incorporated in its entirety by reference herein, inductive wireless power transfer (WPT) systems provide one example of wireless transfer of energy. In an inductive WPT system, a primary power device (or wireless power transmitter) transmits power wirelessly to a secondary power device (or wireless power receiver). Each of the wireless power transmitter and wireless power receiver includes am inductive power transfer structure, typically a single or multi-coil arrangement of windings comprising electric current conveying materials (e.g., copper Litz wire). An alternating current passing through the coil e.g., of a primary wireless power transfer structure produces an alternating magnetic field. When a secondary wireless power transfer structure is placed in proximity to the primary wireless power transfer structure, the alternating magnetic field induces an electromotive force (EMF) into the secondary wireless power transfer structure according to Faraday's law, thereby wirelessly transferring power to the wireless power receiver if a resistive load is connected to the wireless power receiver. To improve a power transfer efficiency, some implementations use a wireless power transfer structure that is part of a resonant structure (resonator). The resonant structure may comprise a capacitively loaded inductor forming a resonance substantially at a fundamental operating frequency of the inductive WPT system (e.g., in the range from 80 kHz to 90 kHz).

Inductive wireless power transfer to electrically chargeable vehicles at power levels of several kilowatts in both domestic and public parking zones may require special protective measures for safety of persons and equipment. Such measures may include detection of foreign objects in an inductive power region of the inductive WPT system where electromagnetic field exposure levels exceed certain limits. This may be particularly true for systems where the inductive power region is open and accessible. Such measures may include detection of electrically conducting (metallic) objects and living objects, (e.g., humans, extremities of humans, or animals) that may be present within or near the inductive power region.

In certain applications for inductive wireless charging of electric vehicles, it may be useful to be able to detect foreign objects that may be present in the inductive power region and that could be susceptible to induction heating due to the high magnetic field strength in that region. In an inductive wireless power transfer system for electric vehicle charging operating at a fundamental frequency in the range from 80 kHz to 90 kHz, magnetic flux densities in the inductive power region (e.g., above a primary wireless power transfer structure) can reach relatively high levels (e.g., above 2 mT) to allow for sufficient power transfer (e.g., 3.3 kW, 7 kW, 11 kW, and the like). Therefore, metallic objects or other objects present in the magnetic field can experience undesirable induction heating. For this reason, foreign object detection (FOD) may be implemented to detect metallic objects or other objects that are affected by the magnetic field generated by the primary or the secondary wireless power transfer structure of the inductive WPT system.

In certain applications for inductive wireless charging of electric vehicles, it may also be useful to be able to detect living objects that may be present within or near an inductive power region where the level of electromagnetic field exposure exceeds certain limits (e.g., as defined by the International Commission on Non-Ionizing Radiation Protection (ICNIRP) recommendation). For this reason, living object detection (LOD) may be implemented to detect living objects (e.g., human extremities, animals), or other objects that may be exposed to the magnetic field generated by the primary or the secondary wireless power transfer structure of the inductive WPT system.

In further applications for inductive wireless charging of electric vehicles, it may also be useful to be able to detect a vehicle or the type of vehicle that may be present above the wireless power transmitter (e.g., above the primary wireless power transfer structure). For this reason, vehicle detection (VD) may be implemented. In yet another application for inductive wireless charging of electric vehicles, it may also be useful to be able to transmit data (e.g., a vehicle identifier or the like) from the vehicle-based secondary device to the ground-based primary device. For this reason, vehicle detection (VD) may be extended for receiving low rate signaling from the vehicle.

Efficiency of an inductive WPT system for electric vehicle charging depends at least in part on achieving sufficient alignment between the ground-based primary wireless power transfer structure and the secondary wireless power transfer structure. Therefore, in certain applications for inductive wireless charging of electric vehicles, it may be useful to be able to determine a position of the vehicle relative to the wireless power transmitter for purposes of guidance and alignment. More specifically, it may be useful to be able to determine a position of the vehicle-based wireless power transfer structure (e.g., the secondary wireless power transfer structure) relative to the ground-based wireless power transfer structure (e.g., the primary wireless power transfer structure). For this reason, position determination (PD) may be implemented.

In an aspect of hardware complexity reduction and cost saving, it may be useful and desirable to provide FOD, LOD, VD, and PD by a common multi-purpose detection circuit.

Discussed herein is an apparatus for determining at least one of a presence of a metallic object, living object, vehicle, type of vehicle, and a vehicle position is provided. The apparatus includes a plurality of inductive sense circuits and a plurality of capacitive sense circuits. Each of the plurality of inductive sense circuits includes at least one inductive sense element (e.g., a sense coil) and an associated capacitive element to compensate for the gross reactance as presented at the terminals of the at least one inductive sense element at an operating frequency herein referred to as the sense frequency. Each of the plurality of capacitive sense circuits includes at least one capacitive sense element (e.g., a sense electrode) and an associated inductive element to compensate for the gross reactance as presented at the terminals of the at least one capacitive sense element at the sense frequency. At least one of the plurality of inductive and capacitive sense circuits also includes an impedance matching element (e.g., a transformer) for transforming the impedance of the sense circuit to match with an operating impedance range of the apparatus. The apparatus further includes a measurement circuit for selectively and sequentially measuring an electrical characteristic (e.g., an impedance) in each of the plurality of inductive and capacitive sense circuits according to a predetermined time multiplexing scheme. More specifically, the measurement circuit includes a driver circuit including multiplexing (input multiplexing) electrically connected to the plurality of inductive and capacitive sense circuits for selectively and sequentially driving each of the plurality of sense circuits with a drive signal (e.g., a current signal) at the sense frequency based on a driver input signal. The measurement circuit further includes a measurement amplifier circuit including multiplexing (output multiplexing) electrically connected to the plurality of inductive and capacitive sense circuits for selectively and sequentially amplifying a measurement signal (e.g., a voltage signal) in each of the plurality of sense circuits and for providing a measurement amplifier output signal indicative of the measurement signal in each of the plurality of sense circuits. The measurement circuit also includes a signal generator circuit electrically connected to the input of the driver circuit for generating the driver input signal. The measurement circuit further includes a signal processing circuit electrically connected to the output of the measurement amplifier circuit for receiving and processing the measurement amplifier output signal and for determining the electrical characteristic in each of the plurality of inductive and capacitive sense circuits based on the driver input signal and the measurement amplifier output signal. The apparatus further includes a control and evaluation circuit electrically connected to the measurement circuit for controlling the signal generator circuit, for controlling the input and output multiplexing according to the predetermined time multiplexing scheme, for evaluating the electrical characteristic as measured in each of the inductive and capacitive sense circuits, and for determining at least one of a presence of a metallic object, living object, vehicle, type of vehicle, and a vehicle position based on changes in the measured electrical characteristics.

Also discussed herein is a method for determining at least one of a presence of a metallic object, living object, vehicle, type of vehicle, and a vehicle position is provided. The method includes selectively and sequentially measuring, in a measurement circuit, an electrical characteristic (e.g., an impedance) in each of the plurality of inductive and capacitive sense circuits according to a predetermined time multiplexing scheme. More specifically, the method includes selectively and sequentially applying, from a driver circuit as part of the measurement circuit and including input multiplexing, a drive signal (e.g., a current signal) at a sense frequency to each of the plurality of inductive and capacitive sense circuits according to the predetermined time multiplexing scheme. The method further includes selectively and sequentially amplifying, in a measurement amplifier circuit as part of the measurement circuit, and including output multiplexing, a measurement signal (e.g., a voltage signal) in each of the plurality of inductive and capacitive sense circuits according to the predetermined time multiplexing scheme, and providing a measurement amplifier output signal indicative for the measurement signal. The method further includes applying, from a signal generator circuit as part of the measurement circuit, a driver input signal to the driver circuit. The method further includes receiving and processing, in a signal processing circuit as part of the measurement circuit, the measurement amplifier output signal, and determining the electrical characteristic in each of the plurality of inductive and capacitive sense circuits based on the driver input signal and the measurement amplifier output signal. The method further includes controlling, in a control and evaluation circuit, the signal generator circuit and the input and output multiplexing according to the time multiplexing scheme. The method further includes evaluating the electrical characteristic as measured in each of the inductive and capacitive sense circuits and determining at least one of a presence of a metallic object, living object, vehicle, type of vehicle, and a vehicle position based on changes in the measured electrical characteristics.

As and additional example, from US 2023/246489 being expressly incorporated in its entirety by reference herein, inductive wireless power transfer (WPT) systems provide one example of wireless transfer of energy. In an inductive WPT system, a primary power device (or wireless power transmitter) transmits power wirelessly to a secondary power device (or wireless power receiver). Each of the wireless power transmitter and the wireless power receiver includes an inductive power transfer structure, typically a single or multi-coil arrangement of windings comprising electric current conveying materials (e.g., copper Litz wire). An alternating current passing through the coil e.g., of a primary WPT structure produces an alternating magnetic field. When a secondary WPT structure is placed in proximity to the primary WPT structure, the alternating magnetic field induces an electromotive force (EMF) into the secondary WPT structure according to Faraday's law, thereby wirelessly transferring power to the wireless power receiver if a resistive load is connected to the wireless power receiver. To improve a power transfer efficiency, some implementations use a WPT structure that is part of a resonant structure (resonator). The resonant structure may comprise a capacitively loaded inductor forming a resonance substantially at a fundamental operating frequency of the inductive WPT system (e.g., in the range from 80 kHz to 90 kHz).

Inductive WPT to electrically chargeable vehicles at power levels of several kilowatts in both domestic and public parking zones may require special protective measures for safety of persons and equipment. Such measures may include detection of foreign objects in an inductive power region of the inductive WPT system where electromagnetic field exposure levels exceed certain limits. This necessity for protective measures may be particularly true for systems where the inductive power region is open and accessible. Such measures may include detection of electrically conducting (metallic) objects and living objects (e.g., humans, extremities of humans, or animals) that may be present within or near the inductive power region.

In certain applications for inductive wireless charging of electric vehicles, it may be useful to be able to detect foreign objects that may be present in the inductive power region and that could be susceptible to induction heating due to the high magnetic field strength in that region. In an inductive WPT system for electric vehicle charging operating at a fundamental frequency in a range from 80 kHz to 90 kHz, magnetic flux densities in the inductive power region (e.g., above a primary WPT structure) can reach relatively high levels (e.g., above 2 milliTeslas (mT)) to allow for sufficient power transfer (e.g., 3.3 kilowatts (KW), 7 kW, 11 kW, and the like). Therefore, metallic objects or other objects present in the magnetic field can experience undesirable induction heating due to eddy current loss effects. In ferromagnetic metallic objects, induction heating may be even more intense due to additional current displacement (skin) and hysteresis loss effects. For this reason, foreign object detection (FOD) may be implemented to detect metallic objects or other objects that are affected by the magnetic field generated by the primary or the secondary WPT structure of the inductive WPT system. Once the presence of a foreign object is detected, the WPT system may reduce power or turn off and issue an alert prompting a user to remove the foreign object. Upon removal of the foreign object, regular power transfer may be resumed, initiated either manually by the user or automatically by the WPT system (e.g., based on an object removal detection).

In certain applications for inductive wireless charging of electric vehicles, it may also be useful to be able to detect living objects that are present within or near an inductive power region where a level of electromagnetic field exposure exceeds certain limits (e.g., as defined by the International Commission on Non-Ionizing Radiation Protection (ICNIRP) recommendation). For this reason, living object detection (LOD) may be implemented to detect living objects (e.g., human extremities, animals) or other objects that may be exposed to the magnetic field generated by the primary or secondary WPT structure of the inductive WPT system. Once the presence of a living object is detected, the WPT system may immediately turn off and automatically resume regular power transfer once the presence of the living object is no more detected or after expiration of a period of time that begins when the presence of the living object is no more detected.

In further applications for inductive wireless charging of electric vehicles, it may also be useful to be able to detect a vehicle or a type of vehicle that is present above the wireless power transmitter (e.g., above the primary WPT structure). For this reason, vehicle detection (VD) may be implemented.

In yet another application for inductive wireless charging of electric vehicles, it may also be useful to be able to transmit data (e.g., a vehicle identifier or the like) from a vehicle-based secondary structure to a ground-based primary structure. For this reason, vehicle detection (VD) may be extended for receiving low rate signaling from the vehicle.

Efficiency of an inductive WPT system for electric vehicle charging depends at least in part on achieving sufficient alignment between a primary WPT structure and the secondary WPT structure. Therefore, in certain applications for inductive wireless charging of electric vehicles, it may be useful to be able to determine a position of the vehicle relative to the wireless power transmitter for purposes of guidance and alignment. More specifically, it may be useful to be able to determine a position of the vehicle-based secondary structure (e.g., the secondary WPT structure) relative to the ground-based primary structure (e.g., the primary WPT structure). For this reason, position determination (PD) may be implemented.

In an aspect of hardware complexity reduction and cost saving, it may be useful and desirable to provide FOD, LOD, VD, and PD by a common detection circuit.

In general, and discussed herein, foreign objects may be detected in an inductive wireless power transfer system based on one or more of an inductive effect and a capacitive effect. A first sense circuit includes a first electrical conductor forming a loop of an inductive sense element and terminating in a first terminal and a second terminal. A second sense circuit includes a second electrical conductor forming an electrode of a capacitive sense element and having a third terminal. A measurement circuit measures a first electrical characteristic between the first terminal and the second terminal and a second electrical characteristic between the first terminal and the third terminal. A controller jointly uses the measured first and second electrical characteristics to determine a presence of the foreign object and to discriminate whether the foreign object is a metallic object or a non-metallic object based on a change in the measured first and second electrical characteristics.

Implementations may include one or more of the following, in any combination. The first electrical conductor of the first sense element may form a balanced loop of at least two turns forming a substantially symmetric structure with respect to a mirror axis, and the electrical conductor may have at least one crossover located on the mirror axis. A capacitor may be coupled between two equal length sections of the first electrical conductor of the first sense element, forming a series resonant circuit tuned to a first operating frequency. The first sense circuit may include a first capacitor coupled between the first electrical conductor and the first terminal and a second capacitor coupled between the first electrical conductor and the second terminal forming a series resonant circuit tuned to a first operating frequency. The second sense circuit may include an inductor coupled between the second electrical conductor and the third terminal forming a series resonant circuit tuned to a second operating frequency. The second sense circuit may include a capacitor coupled between the second electrical conductor and the first terminal in parallel to the capacitive sense element forming a series resonant circuit tuned to the second operating frequency. The second electrical conductor may be a single-turn open loop. At least one of the first electrical characteristic or the second electrical characteristic may be a complex impedance. The first operating frequency may differ from the second operating frequency. The first and second electrical characteristics may be measured in different time intervals according to a time multiplexing scheme.

As and additional example, from US 2019/353816 being expressly incorporated in its entirety by reference herein, wireless power transfer systems (e.g., inductive charging systems for electric vehicles) may include a ground-based wireless power transmitter (e.g., a base pad, base wireless charging system, or some other wireless power transfer device including a coupler (e.g., base coupler)) configured to emit a wireless power field to a wireless power receiver (e.g., a vehicle pad, an electric vehicle wireless charging unit, or some other wireless power receiving device including a coupler (e.g., vehicle coupler)) configured to receive the wireless power field on the bottom of the vehicle. In such wireless power transfer systems, the space between the wireless power transmitter on the ground and the wireless power receiver on the vehicle may be open and accessible by foreign objects. For example, foreign objects may accidentally or intentionally be positioned in the space between the wireless power transmitter and the wireless power receiver. Where the foreign object is conducting or ferromagnetic (e.g., a metallic object, such as a paper clip, screw, etc.)), when the foreign object is exposed to the wireless charging field between the wireless power transmitter and the wireless power receiver, it may reach high temperatures (e.g., over 200 degrees C.), for example due to eddy current and hysteresis effects caused by the wireless charging field, if flux density levels exceed certain critical levels. The high temperatures the foreign object may potentially reach may damage the wireless power transmitter. For example, the foreign object may sit on the wireless power transmitter and cause portions of the wireless power transmitter to melt or burn, or may itself melt into the wireless power transmitter. Further, detecting the foreign object using certain foreign object detection (FOD) techniques may not be feasible, such as due to the object being small and difficult to detect, or may be too costly. Accordingly, a method and apparatus for detecting foreign objects as described is desirable.

Discussed herein is a foreign object detection system. The foreign object detection system includes a heat sensing system comprising a heat sensitive material having a property configured to change as a function of temperature. The foreign object detection system further includes an inductive sensing system comprising one or more sense coils, wherein a change in an electrical characteristic of the one or more sense coils is indicative of presence of a foreign object. The foreign object detection system further includes a controller coupled to the heat sensing system and the inductive sensing system, wherein the controller is configured to determine presence of the foreign object based on at least one of a measure of the property of the heat sensitive material or a measure of the electrical characteristic of the one or more sense coils.

Also discussed herein is a method for controlling a foreign object detection system. The method includes determining a change in a property of a heat sensitive material. The method further includes determining a change in an electrical characteristic of one or more sense coils. The method further includes determining presence of a foreign object based on at least one of the determined change in the property of the heat sensitive material or the determined change in the electrical characteristic of one or more sense coils.

Also discussed herein is a foreign object detection system. The foreign object detection system includes first means for sensing presence of a foreign object based on temperature. The foreign object detection system further includes second means for sensing presence of the foreign object based on inductance. The foreign object detection system further includes means for determining presence of the foreign object based on at least one of the first means for sensing or the second means for sensing.

As and additional example, from WO 2015/175406 being expressly incorporated in its entirety by reference herein, remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless charging systems that are capable of transferring power in free space (e.g., via an electromagnetic field) to be used to charge electric vehicles may overcome some of the deficiencies of wired charging solutions. However, using electromagnetic fields may induce eddy currents in a well conducting (e.g., metallic) object located within the field, potentially causing the object to heat up, vibrate or cause a nearby object to melt or catch fire. As such, wireless charging systems and methods that efficiently and safely transfer power for charging electric vehicles are desirable.

Discussed herein is an apparatus for detecting an object. The apparatus comprises a coil configured to inductively sense a presence of the object based on an electrical characteristic of the coil that varies as a function of a temperature of the object when the object is exposed to an alternating magnetic field. The apparatus further comprises a controller configured to detect a change in the electrical characteristic.

Also discussed herein is a method for detecting a presence of an object. The method comprises sensing a presence of the object based on an electrical characteristic of the coil that varies as a function of a temperature of the object when the object is exposed to an alternating magnetic field. The method further comprises detecting a change in an electrical characteristic.

Also discussed herein is an apparatus for detecting a presence of an object. The apparatus comprises means for sensing a presence of the object based on an electrical characteristic of the coil that varies as a function of a temperature of the object when the object is exposed to an alternating magnetic field. The apparatus further comprises means for detecting a change in an electrical characteristic.

As and additional example, from WO 2021/081382 being expressly incorporated in its entirety by reference herein, inductive wireless power transfer (WPT) systems provide one example of wireless transfer of energy. In an inductive WPT system, a primary power device (or wireless power transmitter) transmits power wirelessly to a secondary power device (or wireless power receiver). Each of the wireless power transmitter and wireless power receiver includes am inductive power transfer structure, typically a single or multi-coil arrangement of windings comprising electric current conveying materials (e.g., copper Litz wire). An alternating current passing through the coil e.g., of a primary wireless power transfer structure produces an alternating magnetic field. When a secondary wireless power transfer structure is placed in proximity to the primary wireless power transfer structure, the alternating magnetic field induces an electromotive force (EMF) into the secondary wireless power transfer structure according to Faraday's law, thereby wirelessly transferring power to the wireless power receiver if a resistive load is connected to the wireless power receiver. To improve a power transfer efficiency, some implementations use a wireless power transfer structure that is part of a resonant structure (resonator). The resonant structure may comprise a capacitively loaded inductor forming a resonance substantially at a fundamental operating frequency of the inductive WPT system (e.g., in the range from 80 kHz to 90 kHz).

Inductive wireless power transfer to electrically chargeable vehicles at power levels of several kilowatts in both domestic and public parking zones may require special protective measures for safety of persons and equipment. Such measures may include detection of foreign objects in an inductive power region of the inductive WPT system where electromagnetic field exposure levels exceed certain limits. This may be particularly true for systems where the inductive power region is open and accessible. Such measures may include detection of electrically conducting (metallic) objects and living objects, (e.g., humans, extremities of humans, or animals) that may be present within or near the inductive power region.

In certain applications for inductive wireless charging of electric vehicles, it may be useful to be able to detect foreign objects that may be present in the inductive power region and that could be susceptible to induction heating due to the high magnetic field strength in that region. In an inductive wireless power transfer system for electric vehicle charging operating at a fundamental frequency in the range from 80 kHz to 90 kHz, magnetic flux densities in the inductive power region (e.g., above a primary wireless power transfer structure) can reach relatively high levels (e.g., above 2 mT) to allow for sufficient power transfer (e.g., 3.3 kW, 7 kW, 11 kW, and the like). Therefore, metallic objects or other objects present in the magnetic field can experience undesirable induction heating. For this reason, foreign object detection (FOD) may be implemented to detect metallic objects or other objects that are affected by the magnetic field generated by the primary or the secondary wireless power transfer structure of the inductive WPT system.

In certain applications for inductive wireless charging of electric vehicles, it may also be useful to be able to detect living objects that may be present within or near an inductive power region where the level of electromagnetic field exposure exceeds certain limits (e.g., as defined by the International Commission on Non-Ionizing Radiation Protection (ICNIRP) recommendation). For this reason, living object detection (LOD) may be implemented to detect living objects (e.g., human extremities, animals), or other objects that may be exposed to the magnetic field generated by the primary or the secondary wireless power transfer structure of the inductive WPT system.

In further applications for inductive wireless charging of electric vehicles, it may also be useful to be able to detect a vehicle or the type of vehicle that may be present above the wireless power transmitter (e.g., above the primary wireless power transfer structure). For this reason, vehicle detection (VD) may be implemented. In yet another application for inductive wireless charging of electric vehicles, it may also be useful to be able to transmit data (e.g., a vehicle identifier or the like) from the vehicle-based secondary device to the ground-based primary device. For this reason, vehicle detection (VD) may be extended for receiving low rate signaling from the vehicle.

Efficiency of an inductive WPT system for electric vehicle charging depends at least in part on achieving sufficient alignment between the ground-based primary wireless power transfer structure and the secondary wireless power transfer structure. Therefore, in certain applications for inductive wireless charging of electric vehicles, it may be useful to be able to determine a position of the vehicle relative to the wireless power transmitter for purposes of guidance and alignment. More specifically, it may be useful to be able to determine a position of the vehicle-based wireless power transfer structure (e.g., the secondary wireless power transfer structure) relative to the ground-based wireless power transfer structure (e.g., the primary wireless power transfer structure). For this reason, position determination (PD) may be implemented.

In an aspect of hardware complexity reduction and cost saving, it may be useful and desirable to provide FOD, LOD, VD, and PD by a common multi-purpose detection circuit.

Discussed herein is an apparatus for determining at least one of a presence of a metallic object, living object, vehicle, type of vehicle, and a vehicle position. The apparatus includes a plurality of inductive sense circuits and a plurality of capacitive sense circuits. Each of the plurality of inductive sense circuits includes at least one inductive sense element (e.g., a sense coil) and an associated capacitive element to compensate for the gross reactance as presented at the terminals of the at least one inductive sense element at an operating frequency herein referred to as the sense frequency. Each of the plurality of capacitive sense circuits includes at least one capacitive sense element (e.g., a sense electrode) and an associated inductive element to compensate for the gross reactance as presented at the terminals of the at least one capacitive sense element at the sense frequency. At least one of the plurality of inductive and capacitive sense circuits also includes an impedance matching element (e.g., a transformer) for transforming the impedance of the sense circuit to match with an operating impedance range of the apparatus. The apparatus further includes a measurement circuit for selectively and sequentially measuring an electrical characteristic (e.g., an impedance) in each of the plurality of inductive and capacitive sense circuits according to a predetermined time multiplexing scheme. More specifically, the measurement circuit includes a driver circuit including multiplexing (input multiplexing) electrically connected to the plurality of inductive and capacitive sense circuits for selectively and sequentially driving each of the plurality of sense circuits with a drive signal (e.g., a current signal) at the sense frequency based on a driver input signal. The measurement circuit further includes a measurement amplifier circuit including multiplexing (output multiplexing) electrically connected to the plurality of inductive and capacitive sense circuits for selectively and sequentially amplifying a measurement signal (e.g., a voltage signal) in each of the plurality of sense circuits and for providing a measurement amplifier output signal indicative of the measurement signal in each of the plurality of sense circuits. The measurement circuit also includes a signal generator circuit electrically connected to the input of the driver circuit for generating the driver input signal. The measurement circuit further includes a signal processing circuit electrically connected to the output of the measurement amplifier circuit for receiving and processing the measurement amplifier output signal and for determining the electrical characteristic in each of the plurality of inductive and capacitive sense circuits based on the driver input signal and the measurement amplifier output signal. The apparatus further includes a control and evaluation circuit electrically connected to the measurement circuit for controlling the signal generator circuit, for controlling the input and output multiplexing according to the predetermined time multiplexing scheme, for evaluating the electrical characteristic as measured in each of the inductive and capacitive sense circuits, and for determining at least one of a presence of a metallic object, living object, vehicle, type of vehicle, and a vehicle position based on changes in the measured electrical characteristics.

Also discussed herein is a method for determining at least one of a presence of a metallic object, living object, vehicle, type of vehicle, and a vehicle position. The method includes selectively and sequentially measuring, in a measurement circuit, an electrical characteristic (e.g., an impedance) in each of the plurality of inductive and capacitive sense circuits according to a predetermined time multiplexing scheme. More specifically, the method includes selectively and sequentially applying, from a driver circuit as part of the measurement circuit and including input multiplexing, a drive signal (e.g., a current signal) at a sense frequency to each of the plurality of inductive and capacitive sense circuits according to the predetermined time multiplexing scheme. The method further includes selectively and sequentially amplifying, in a measurement amplifier circuit as part of the measurement circuit, and including output multiplexing, a measurement signal (e.g., a voltage signal) in each of the plurality of inductive and capacitive sense circuits according to the predetermined time multiplexing scheme, and providing a measurement amplifier output signal indicative for the measurement signal. The method further includes applying, from a signal generator circuit as part of the measurement circuit, a driver input signal to the driver circuit. The method further includes receiving and processing, in a signal processing circuit as part of the measurement circuit, the measurement amplifier output signal, and determining the electrical characteristic in each of the plurality of inductive and capacitive sense circuits based on the driver input signal and the measurement amplifier output signal. The method further includes controlling, in a control and evaluation circuit, the signal generator circuit and the input and output multiplexing according to the time multiplexing scheme. The method further includes evaluating the electrical characteristic as measured in each of the inductive and capacitive sense circuits and determining at least one of a presence of a metallic object, living object, vehicle, type of vehicle, and a vehicle position based on changes in the measured electrical characteristics.

Wireless power transfer (WPT) for charging electric vehicles is also described in detail in patents such as U.S. Pat. No. 8,933,594, titled “Wireless energy transfer for vehicles,” and U.S. Pat. No. 9,561,730, titled “Wireless power transmission in electric vehicles,” which are incorporated here by reference in their entirety. One aspect of wireless power transfer for electric vehicle charging to be addressed is establishing communications between the vehicle and the WPT station at which the vehicle is parked. This establishment of communications can be particularly difficult in a facility with multiple WPT stations, at which multiple vehicles may be attempting to park at the same me. It is necessary to disambiguate the connections—that is, make sure that each vehicle is actually in communication with the WPT station it is attempting to use, and not another nearby station. Electric vehicles that plug in to power transfer stations may also use wireless communication for connection-related communications, in which case they have the same need for assuring that they are in wireless communication with the same station to which they are connected by wire.

While examples described herein are directed to making use of inductive sensing for foreign object detection, examples will be appreciated wherein any suitable foreign object sensing technology may be used, such as capacitive sensing.

The present disclosure may be further understood with reference to the following examples:

Example 1: A computer-implemented method for foreign object detection (FOD) in a wireless power transfer (WPT) system, the method comprising: detecting, using control circuitry, that a foreign object is within a proximity of a WPT surface of a WPT system; accessing, using control circuitry, a first dataset of FOD sensitivity values of the WPT system, the first dataset representing a foreign object detection threshold of a WPT system; and a second dataset of foreign object detection values for an object obtained by the WPT system; generating, using control circuitry, a first probability density function (PDF) from the first dataset; generating, using control circuitry, a second PDF from the second dataset; determining, using control circuitry, based on the first PDF and the second PDF, a third PDF representing a probability of a missed detection of the object; and modifying, using control circuitry, based on the third PDF, the foreign object detection threshold for detecting the object by the WPT system; and outputting, using control circuitry, a warning of a foreign object detection event based on the modified foreign object detection threshold.

Example 2: The method of Example 1, wherein the method further comprises: using the third PDF to defining a missed detection probability of the WPT system based on the third PDF.

Example 3: The method of Example 2, wherein defining the missed detection probability comprises summing the third PDF across one or more regions of interest.

Example 4: The method of Example 1, Example 2, or Example 3, wherein the foreign object detection threshold is selected from a detection threshold range between a minimum detection threshold and a maximum detection threshold; optionally wherein modifying the foreign object detection threshold based on the third PDF comprises modifying the detection threshold range.

Example 5: The method of any one of Examples 1 to 4, wherein the FOD sensitivity values comprise, or are associated with, one or more selected from: one or more object detection sensors indicating inductive responses or capacitive responses above the foreign object detection threshold; a magnitude of said inductive responses or capacitive responses.

Example 6: The method of any one of Examples 1 to 5, wherein the first dataset comprises time series data.

Example 7: The method of any one of Examples 1 to 6, wherein accessing the first dataset comprises: measuring the sensitivity values using a plurality of object detection sensors of a FOD system of the WPT system, during a period of normal use of the WPT system, and in the absence of the object.

Example 8: The method of Example 7 when dependent on Example 4, wherein selecting of the detection threshold along the detection threshold range comprises: determining from the plurality of object detection sensors, a number of the sensors indicating the proximity of an object; and selecting the detection threshold from along the range of the detection thresholds according to the number of sensors.

Example 9: The method of Example 8, wherein the proximity of the selected detection threshold to the maximum detection threshold of the range is correlated with the number of sensors indicating the proximity of an object.

Example 10: The method of any one of Examples 1 to 9, wherein the foreign object detection values comprise, or are associated with, one or more selected from: an inductive response or a capacitive response caused by an object; a location of an inductive response or a capacitive response caused by an object.

Example 11: The method of any one of Examples 1 to 10, wherein accessing the second dataset comprises: measuring the foreign object detection values using a FOD system of the WPT system, during a period of normal use of the WPT system, and in the presence of the object.

Example 12: The method of Example 11, wherein the FOD system of the WPT system comprises one or more object detection sensors disposed proximate a WPT surface of the WPT system, the one or more object detection sensors arranged to detect a change in a foreign object detection parameter for generating the foreign object detection values, and wherein accessing the second dataset comprises: positioning the object proximate the WPT surface at one or more locations relative to the one or more object detection sensors.

Example 13: The method of any one of Examples 12, wherein accessing the second dataset further comprises: positioning the object at each location of a plurality of the locations.

Example 14: The method of any one of Examples 1 to 15, wherein generating the second PDF comprises generating a plurality of second PDFs, each second PDF generated from a corresponding second dataset of foreign object detection values for a corresponding object.

Example 15: The method of any one of Examples 1 to 14, wherein the first, second and third PDFs are first, second and third probability density functions respectively.

Example 16: A non-transitory computer readable storage medium storing instructions which, when executed by a processor, are arranged to perform steps of a method of any one of Examples 1 to 15.

Example 17: A foreign object detection (FOD) system of a wireless power transfer (WPT) system, the FOD system comprising control circuitry configured to: detect that a foreign object is within a proximity of a WPT surface of a WPT system; access a first dataset of FOD sensitivity values of the WPT system, the first dataset representing a foreign object detection threshold of a WPT system; and a second dataset of foreign object detection values for an object obtained by the WPT system; generate a first probability density function (PDF) from the first dataset; generate a second PDF from the second dataset; and determine using the first PDF and the second PDF, a third PDF representing a probability of a missed detection of the object; modify, based on the third PDF, the foreign object detection threshold for detecting the object by the WPT system; and output a warning of a foreign object detection event based on the modified foreign object detection threshold.

Example 18: The FOD system of Example 17, wherein the control circuitry is further configured to: define a missed detection probability of the WPT system based on the third PDF.

Example 19: The FOD system of Example 18, wherein defining the missed detection probability comprises summing the third PDF across one or more regions of interest.

Example 20: The FOD system of Example 17, Example 18 or Example 19, wherein the foreign object detection threshold is one selected from a detection threshold range between a minimum detection threshold and a maximum detection threshold; wherein modifying the foreign object detection threshold based on the third PDF comprises modifying the detection threshold range.

Example 21: The FOD system of any one of Examples 17 to 20, wherein the FOD sensitivity values comprise, or are associated with, one or more selected from: a number of object detection sensors indicating responses (such as inductive or capacitive responses) above the detection threshold; a magnitude of said responses (for example inductive or capacitive responses).

Example 22: The FOD system of any one of Examples 17 to 21, wherein the first dataset comprises time series data.

Example 23: The FOD system of any one of Examples 17 to 22, wherein accessing the first dataset comprises: measuring the sensitivity values using a plurality of object detection sensors of a FOD system of the WPT system, during a period of normal use of the WPT system, and in the absence of the object.

Example 24: The FOD system of Example 23 when dependent on Example 39, wherein selecting of the detection threshold along the detection threshold range comprises: determining from the plurality of object detection sensors, a number of the sensors indicating the proximity of an object; and selecting the detection threshold from along the range of the detection thresholds according to the number of sensors.

Example 25: The FOD system of Example 24, wherein the proximity of the selected detection threshold to the maximum detection threshold of the range is correlated with the number of sensors indicating the proximity of an object.

Example 26: The FOD system of any one of Examples 17 to 25, wherein the foreign object detection values comprise, or are associated with, one or more selected from: an inductive response or a capacitive response caused by an object; a location of an inductive response or a capacitive response caused by an object.

Example 27: The FOD system of any one of Examples 17 to 26, wherein accessing the second dataset comprises: measuring the foreign object detection values using a FOD system of the WPT system, during a period of normal use of the WPT system, and in the presence of the object.

Example 28: The FOD system of Example 27, wherein the FOD system of the WPT system comprises one or more object detection sensors disposed proximate a WPT surface of the WPT system, the one or more object detection sensors arranged to detect a change in an foreign object detection parameter for generating the foreign object detection values, and wherein accessing the second dataset comprises: positioning the object proximate the WPT surface at one or more locations relative to the one or more object detection sensors.

Example 29: The FOD system of any one of Examples 28, wherein accessing the second dataset comprises: positioning the object at each location of a plurality of the locations.

Example 30: The FOD system of any one of Examples 17 to 29, wherein generating the second PDF comprises generating a plurality of second PDFs, each second PDF generated from a corresponding second dataset of foreign object detection values for a corresponding object.

Example 31: The FOD system of any one of Examples 17 to 30, wherein the first, second and third PDFs are first, second and third probability density functions respectively.

The processes and systems described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Only the claims that follow are intended to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method of foreign object detection (FOD) in a wireless power transfer (WPT) system, the method comprising:
detecting, using control circuitry, that a foreign object is within a proximity of a WPT surface of a WPT system;
accessing, using control circuitry, a first dataset of FOD sensitivity values of the WPT system, the first dataset representing a foreign object detection threshold of a WPT system; and a second dataset of foreign object detection values for an object obtained by the WPT system;
generating, using control circuitry, a first probability distribution function (PDF) from the first dataset;
generating, using control circuitry, a second PDF from the second dataset;
determining, using control circuitry, based on the first PDF and the second PDF, a third PDF representing a probability of a missed detection of the object;
modifying, using control circuitry, based on the third PDF, the foreign object detection threshold for detecting the object by the WPT system; and
outputting, using control circuitry, a warning of a foreign object detection event based on the modified foreign object detection threshold.

2. The method as claimed in claim 1, wherein the method further comprises:
defining a missed detection probability of the WPT system based on the third PDF.

3. The method as claimed in claim 2, wherein defining the missed detection probability comprises summing the third PDF across one or more regions of interest.

4. The method as claimed in claim 1, wherein the foreign object detection threshold is selected from a detection threshold range between a minimum detection threshold and a maximum detection threshold;
wherein modifying the foreign object detection threshold based on the third PDF comprises modifying the detection threshold range.

5. The method as claimed in claim 1, wherein the FOD sensitivity values comprise, or are associated with, one or more selected from: one or more object detection sensors indicating inductive responses or capacitive responses above the foreign object detection threshold; a magnitude of said inductive responses or capacitive responses.

6. The method as claimed in claim 1, wherein the first dataset comprises time series data.

7. The method as claimed in claim 1, wherein accessing the first dataset comprises: measuring the sensitivity values using a plurality of object detection sensors of a FOD system of the WPT system, during a period of normal use of the WPT system, and in the absence of the object.

8. The method as claimed in claim 7, wherein selecting of the detection threshold along the detection threshold range comprises: determining from the plurality of object detection sensors, a number of the sensors indicating the proximity of an object; and selecting the detection threshold from along the range of the detection thresholds according to the number of sensors; and optionally, wherein the proximity of the selected detection threshold to the maximum detection threshold of the range is correlated with the number of sensors indicating the proximity of an object.

9. The method as claimed in claim 1, wherein the foreign object detection values comprise, or are associated with, one or more selected from: an inductive response or a capacitive response caused by an object; a location of an inductive response or capacitive response caused by an object.

10. The method as claimed in claim 1, wherein accessing the second dataset comprises: measuring the foreign object detection values using a FOD system of the WPT system, during a period of normal use of the WPT system, and in the presence of the object; and optionally,
wherein the FOD system of the WPT system comprises one or more object detection sensors disposed proximate a WPT surface of the WPT system, the one or more object detection sensors arranged to detect a change in a foreign object detection parameter for generating the foreign object detection values, and wherein accessing the second dataset comprises: positioning the object proximate the WPT surface at one or more locations relative to the one or more object detection sensors.

11. A non-transitory computer readable storage medium storing instructions which, when executed by a processor of a computing device, are arranged to perform steps of a method as claimed in claim 1.

12. A foreign object detection (FOD) system of a wireless power transfer (WPT) system, the FOD system comprising control circuitry configured to:
detect that a foreign object is within a proximity of a WPT surface of a WPT system;
access a first dataset of FOD sensitivity values of the WPT system, the first dataset representing a foreign object detection threshold of a WPT system; and a second dataset of foreign object detection values for an object obtained by the WPT system;
generate a first probability distribution function (PDF) from the first dataset;
generate a second PDF from the second dataset; and
determine using the first PDF and the second PDF, a third PDF representing a probability of a missed detection of the object; and
modify, based on the third PDF, the foreign object detection threshold for detecting the object by the WPT system; and
output a warning of a foreign object detection event based on the modified foreign object detection threshold.

13. The FOD system as claimed in claim 12, wherein the control circuitry is further configured to:
define a missed detection probability of the WPT system based on the third PDF.

14. The FOD system as claimed in claim 13, wherein defining the missed detection probability comprises summing the third PDF across one or more regions of interest.

15. The FOD system as claimed in claim 12, wherein the foreign object detection threshold is one selected from a detection threshold range between a minimum detection threshold and a maximum detection threshold;
wherein modifying the foreign object detection threshold based on the third PDF comprises modifying the detection threshold range.

16. The FOD system as claimed in claim 12, wherein the FOD sensitivity values comprise, or are associated with, one or more selected from: a number of object detection sensors indicating inductive responses or capacitive responses above the detection threshold; a magnitude of said inductive responses or capacitive responses.

17. The FOD system as claimed in claim 12, wherein accessing the first dataset comprises: measuring the sensitivity values using a plurality of object detection sensors of a FOD system of the WPT system, during a period of normal use of the WPT system, and in the absence of the object.

18. The FOD system as claimed in claim 12, wherein selecting of the detection threshold along the detection threshold range comprises: determining from the plurality of object detection sensors, a number of the sensors indicating the proximity of an object; and selecting the detection threshold from along the range of the detection thresholds according to the number of sensors; and optionally,
wherein the proximity of the selected detection threshold to the maximum detection threshold of the range is correlated with the number of sensors indicating the proximity of an object.

19. The FOD system as claimed in claim 12, wherein the foreign object detection values comprise, or are associated with, one or more selected from: an inductive response or a capacitive response caused by an object; a location of an inductive response or a capacitive response caused by an object.

20. The FOD system as claimed in claim 12, wherein accessing the second dataset comprises: measuring the foreign object detection values using a FOD system of the WPT system, during a period of normal use of the WPT system, and in the presence of the object; and optionally,
wherein the FOD system of the WPT system comprises one or more object detection sensors disposed proximate a WPT surface of the WPT system, the one or more object detection sensors arranged to detect a change in an foreign object detection parameter for generating the foreign object detection values, and wherein accessing the second dataset comprises: positioning the object proximate the WPT surface at one or more locations relative to the one or more object detection sensors.
